(19) United States
(12) Patent Application Publication
(10) Pub. No.: US 2013/0325915 A1
(43) Pub. Date: Dec. 5, 2013

(54) Computer System And Data Management Method

(71) Applicant: Toshiyuki Ukai, Machida (JP)

(72) Inventor: Toshiyuki Ukai, Machida (JP)

(73) Assignee: Hitachi, Ltd., Chiyoda-ku, Tokyo (JP)

(21) Appl. No.: 13/823,186

(22) PCT Filed: Mar. 1, 2011
(86) PCT No.: PCT/JP2011/054646

§ 371 Date: Mar. 14, 2013

(30) Foreign Application Priority Data
Feb. 23, 2011 (JP) 2011-036880

(51) Int. Cl. G06F 17/30

(52) U.S. Cl. CPC G06F 17/30194
USPC 707/827

(57) ABSTRACT

A computer system, comprising: a plurality of computers for storing data; a management computer for managing the data; and a storage, the management computer stores: storage configuration information including information on the storage areas; and file management information including information relevant to placement of the plurality of pieces of division data; the management computer is configured to: identify the file system being a storage destination of a file, in a case of receiving a file generation request including the file identification information on the file from at least one of applications; refer to the storage configuration information to determine the placement method for the plurality of pieces of division data, generated from the plurality of pieces of file data of the file; generate the file management information.

### CLAIM OF PRIORITY

This application is based upon and claims the benefit of priority from the corresponding Japanese Patent Application No. 2011-36880 filed on Feb. 23, 2011, the entire contents of which are incorporated herein by reference.

### BACKGROUND OF THE INVENTION

This invention relates to a computer system including a storage for placing data in a distributed manner and a data management method therefore.

In recent years, computer systems have been experiencing an explosive growth in data amount processed by applications. There arises a problem that processing such as a batch job cannot be completed within a predetermined time due to an increase in processing time in accordance with the growth in data amount handled by a computer system. Therefore, in order to realize an increase in processing speed, there is a demand that a plurality of servers process mass data in parallel.

In conventional applications, a file access interface is used to process data in a file format. There exist various methods of handling files on an application-to-application basis. For example, an application for executing a core task processing using a mainframe is described by using a program language such as COBOL.

FIG. 25 is an explanatory diagram illustrating an example of a conventional structure of a file.

A file 2500 is formed of a plurality of records. In the example of FIG. 25, the file 2500 includes a record 2501, a record 2502, a record 2503, and a record 2504.

The application handles the file as a set of records, and inputs/outputs data on a record-to-record basis. In other words, the record is a base unit of data processed by the application.

Further, one record is formed of items called “fields”. The field stores corresponding data. In the example of FIG. 25, each of the records includes a field 2511, a field 2512, and a field 2513.

Parallel processing may be realized by a method of dividing the data (file) into a plurality of pieces and controlling the application on each server to process the divided data. For example, it is conceivable to employ a method of dividing the file on a record-to-record basis and controlling the application on each server to process the divided file.

As the above-mentioned dividing method, there is a distributed database technology for dividing data stored in the database based on a key (see, for example, Japanese Patent Application Laid-open No. Hei 5-334165). Japanese Patent Application Laid-open No. Hei 5-334165 describes that the parallel processing can be realized by dividing the data stored in the database based on a key range (range of key) on a record-to-record basis.

Further, there is known a technology for dividing mass data in a mesh shape or according to a predetermined rule and controlling respective computers to execute the parallel processing thereof (see, for example, Japanese Patent Application Laid-open No. Hei 7-219905).

On the other hand, in order to realize the increase in processing speed, there is known a distributed memory technology for integrating memories provided to the plurality of servers to form at least one memory space and processing the data on the memory space (see, for example, GemStone, “Gem Fire Enterprise”, June, 2007).

In the distributed memory technology, the parallel processing is realized by placing the data on each server in a distributed manner, and the data is input/output on the memory of each server, which enables the increase in processing speed.

In the distributed memory technology, a key-value data format is employed. The key-value data has a data structure obtained by associating a key being an identifier of data with a value indicating details of data, and is managed in a format of (key, value).

### SUMMARY OF THE INVENTION

In the distributed memory technology, the key-value data is placed on the plurality of servers based on the key range (range of key). The application on each server processes the key-value data placed on the each server, to thereby realize the parallel processing in the entire computer system, which enables the increase in processing speed.

An entity of the key-value data is an object of an object-oriented system, and hence the application used for the key-value data is described in an object-oriented language. For example, Get/Put is generally used as an API used in the distributed memory technology to acquire a value by designating a key and add data by designating a combination of (key, value).

In order to apply the above-mentioned distributed memory technology, it is necessary to divide the file into a plurality of pieces of key-value data. In this case, one field included in the record may be set as the key, and another field included in the record may be set as the value.

However, with the distributed memory technology using the key-value data, the conventional application for processing the data in the file format as described above cannot be used as it is. This necessitates development of a new application compatible with the key-value data (object).

Further, in the distributed memory technology, the records are sorted by using the designated field as the key, and the file is divided based on a predetermined key range. At this time, when there is an application using another field as the key, it is necessary to execute sort processing and file dividing processing again, which complicates the processing.

This invention has been made in view of the above-mentioned problems. In other words, this invention provides a data management method for distributed data which can associate the plurality of pieces of key-value data with each other so that the plurality of pieces of value data can be handled on a name space of a file system and perform distributed placement of the plurality of pieces of key-value data by using a file access interface.

The present invention can be appreciated by the description which follows in conjunction with the following figures, wherein: a computer system, comprising a plurality of computers for storing data, a management computer for managing the data stored on each of the plurality of computers, and a storage generated by integrating storage areas provided to each of the plurality of computers. Each of the plurality of computers each have a first processor, a first memory coupled to the first processor, and a first network interface coupled to the first processor. The management computer has a second processor, a second memory coupled to the second processor, and a second network interface coupled to the second processor. The storage divides a file including a plurality of pieces of file data, and stores a plurality of pieces of division data, each of which is formed of a search key and one of the plurality of pieces of file data, in the storage areas that form the storage in a distributed manner. The management computer includes an access management module for controlling access to the storage, and a storage management module for managing the storage. The management computer stores storage configuration information including information on the storage areas that form the storage, and file management information including information relevant to placement of the plurality of pieces of division data stored on the storage. The storage management module stores file identification information including information for identifying the file corresponding to the plurality of pieces of division data stored on the storage and a file system in which the file is stored; and file system management information including placement definition information for defining a placement method for the plurality of pieces of division data on the storage on which the file system is built. The each of the plurality of computers has an application for processing data in units of the plurality of pieces of file data; and a data access management module for accessing the storage. The management computer is configured to: identify the file system being a storage destination of a given file based on the file identification information on the given file, and retrieve the file system management information corresponding to the identified file system, in a case of receiving a file generation request including the file identification information on the given file from at least one of the applications, register the file identification information on the given file in the retrieved file system management information, refer to the storage configuration information and the retrieved file system management information to determine the placement method for the plurality of pieces of division data, generated from the plurality of pieces of file data of the given file, to the storage areas that form the storage, generate the file management information based on the determined placement method, refer to the file management information based on the file identification information on an given file to identify the plurality of computers that store the plurality of pieces of division data of the given file, in a case of receiving an access request including the file identification information on the given file from at least one of the applications, and set a pointer for access to the plurality of pieces of division data of the given file stored on the identified plurality of computers.

According to the exemplary embodiment of this invention, the application can access the plurality of pieces of file data placed on the respective computers in a distributed manner in response to the access request including the file identification information.

### BRIEF DESCRIPTION OF THE DRAWINGS

The present invention can be appreciated by the description which follows in conjunction with the following figures, wherein:

FIG. 1 is an explanatory diagram illustrating a configuration example of a computer system according to the embodiment of this invention;

FIG. 2 is an explanatory diagram illustrating an example of a source program of an AP according to the embodiment of this invention;

FIG. 3 is an explanatory diagram illustrating a logical configuration example of a distributed memory storage according to the embodiment of this invention;

FIG. 4 is an explanatory diagram illustrating details of a distributed memory storage management module and a key-value data management module according to the embodiment of this invention;

FIG. 5 is an explanatory diagram illustrating details of distributed memory storage configuration information according to the embodiment of this invention;

FIG. 6 is an explanatory diagram illustrating details of distributed memory storage management information according to the embodiment of this invention;

FIG. 7 is an explanatory diagram illustrating details of global file management information according to the embodiment of this invention;

FIG. 8 is an explanatory diagram illustrating details of management attribute information according to the embodiment of this invention;

FIG. 9 is an explanatory diagram illustrating details of local file management information according to the embodiment of this invention;

FIG. 10 is an explanatory diagram illustrating a logical configuration example of an entry according to the embodiment of this invention;

FIG. 11 is an explanatory diagram illustrating details of directory management information according to the embodiment of this invention;

FIG. 12 is an explanatory diagram illustrating details of placement attribute information according to the embodiment of this invention;

FIG. 13 is an explanatory diagram illustrating details of mount information according to the embodiment of this invention;

FIG. 14 is an explanatory diagram illustrating details of open file information according to the embodiment of this invention;

FIG. 15 is a flowchart illustrating a mount processing according to the embodiment of this invention;

FIG. 16 is a flowchart illustrating an unmount processing according to the embodiment of this invention;

FIGS. 17A and 17B are flowcharts illustrating an open processing according to the embodiment of this invention;

FIG. 18 is a flowchart illustrating a read processing performed on the distributed memory storage according to the embodiment of this invention;

FIG. 19 is a flowchart illustrating a write processing performed on the distributed memory storage according to the embodiment of this invention;

FIG. 20 is an explanatory diagram illustrating an example of a directory structure according to the embodiment of this invention;

FIG. 21 is an explanatory diagram illustrating a placement example of a key-value data in a case where a data of a file is copied between directories according to the embodiment of this invention;

FIGS. 22A, 22B, and 22C are explanatory diagrams illustrating a correspondence between an input from a server and a response from a management server according to the embodiment of this invention;

FIG. 23 is an explanatory diagram illustrating details of record definition information according to the embodiment of this invention;

FIG. 24 is an explanatory diagram illustrating an example of file status information according to the embodiment of this invention; and

FIG. 25 is an explanatory diagram illustrating an example of a conventional structure of a file.

### DETAILED DESCRIPTION OF THE PREFERRED EMBODIMENT

An embodiment of this invention is described below with reference to the accompanying drawings.

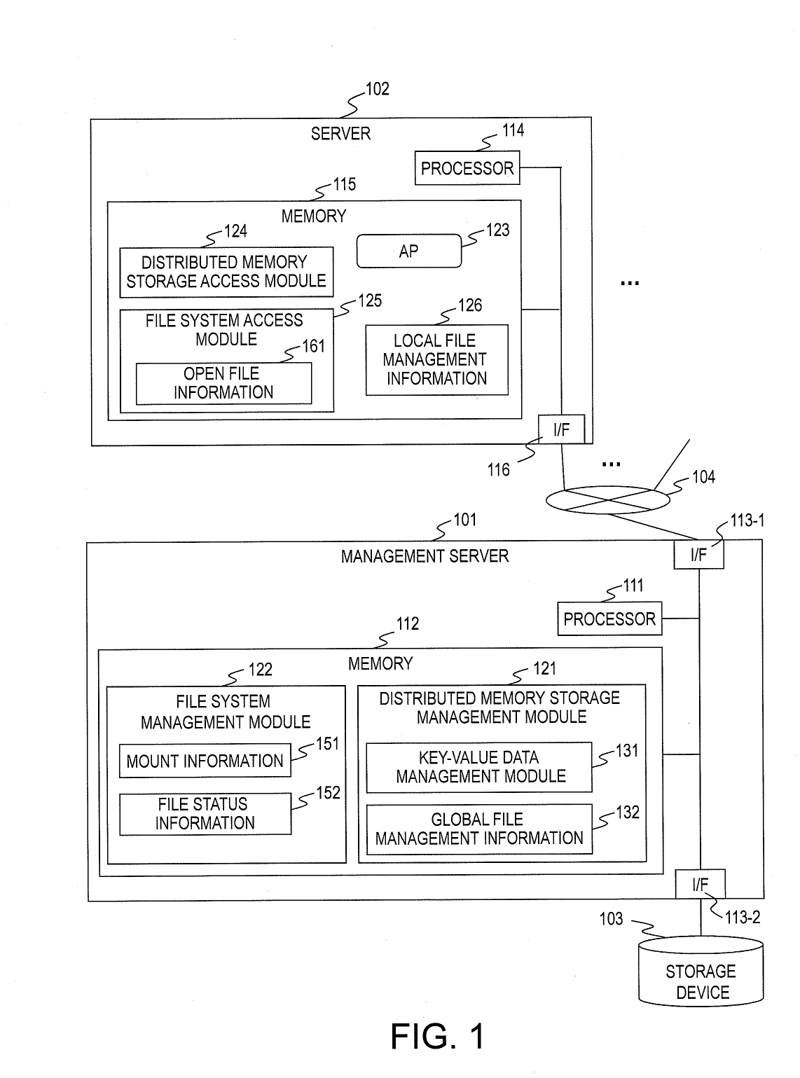

FIG. 1 is an explanatory diagram illustrating a configuration example of a computer system according to the embodiment of this invention.

The computer system according to this embodiment includes a management server 101 and a plurality of servers 102.

The management server 101 is coupled to the plurality of servers 102 via a network 104, and manages all the servers 102 coupled thereto. The network 104 may be a WAN, a LAN, an IP network, or the like. It should be noted that the management server 101 may be coupled directly to each of the servers 102.

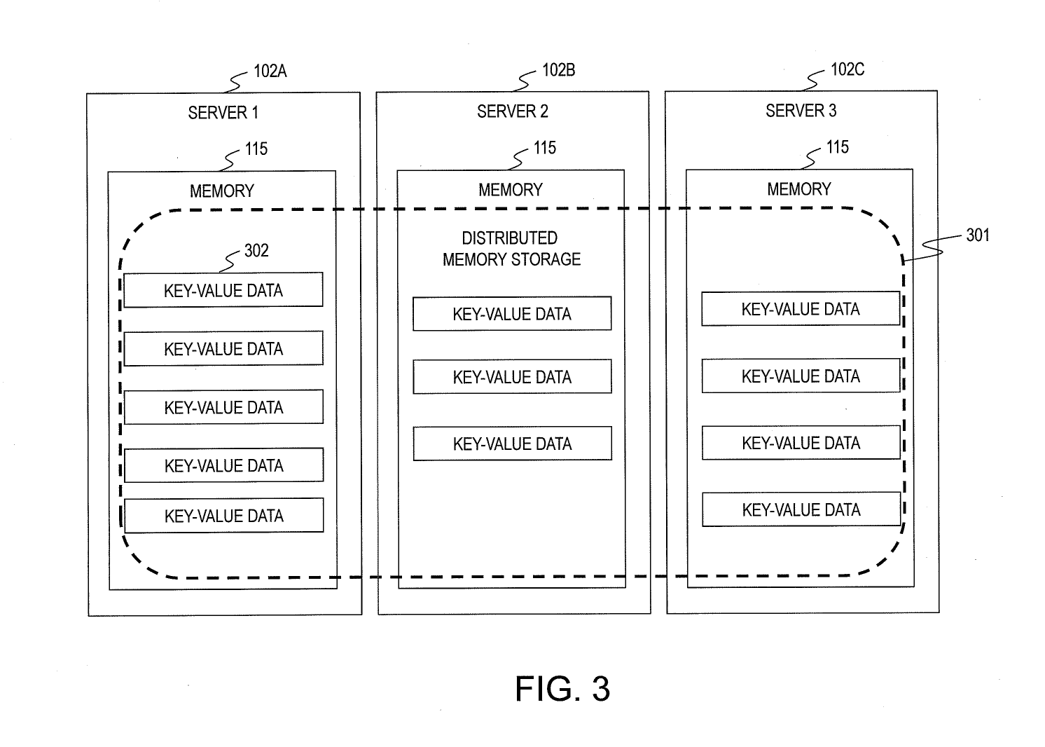

In this embodiment, a distributed memory storage is generated from a storage area generated by integrating memory areas of the respective servers 102. The distributed memory storage is described later in detail with reference to FIG. 3. The distributed memory storage according to this embodiment stores data of a file. It should be noted that the data of the file is stored on the distributed memory storage as a plurality of pieces of key-value data.

Further, the management server 101 is coupled to a storage device 103. The storage device 103 stores the file being a subject to be processed. The storage device 103 may be any storage device that can retain the file permanently. For example, the storage device 103 may be a storage system including a plurality of storage media such as HDDs, a solid state disk drive using a flash memory as a storage medium, or an optical disc drive.

It should be noted that in this embodiment, the file is formed of a plurality of records. Further, the record is formed of at least one field.

The management server 101 includes a processor 111, a memory 112, and interfaces 113-1 and 113-2. The processor 111, the memory 112, and the interfaces 113-1 and 113-2 are coupled to one another by using an internal bus or the like. It should be noted that the management server 101 may include another component such as an input/output unit for inputting/outputting information.

The processor 111 executes a program read onto the memory 112, to thereby realize a function provided to the management server 101.

The memory 112 stores the program executed by the processor 111 and information necessary to execute the program. Specifically, the memory 112 stores a program for realizing a distributed memory storage management module 121 and a file system management module 122.

The distributed memory storage management module 121 manages the distributed memory storage. The distributed memory storage management module 121 includes at least a key-value data management module 131 and global file management information 132.

The key-value data management module 131 manages the key-value data stored on the distributed memory storage.

The global file management information 132 stores management information on positions in which the plurality of pieces of key-value data obtained by dividing the file are placed on a distributed memory storage 301, in other words, information relating to a correlation with local file management information 126.

It should be noted that detailed configurations of the distributed memory storage management module 121 and the key-value data management module 131 are described later with reference to FIG. 3.

The file system management module 122 manages the files stored on the storage device 103 and the distributed memory storage 301 (see FIG. 3) and a file system for storing the files. The file system management module 122 executes input/output processing for the file based on identification information on the file such as a name of the file.

Further, the file system management module 122 includes mount information 151 and file status information 152.

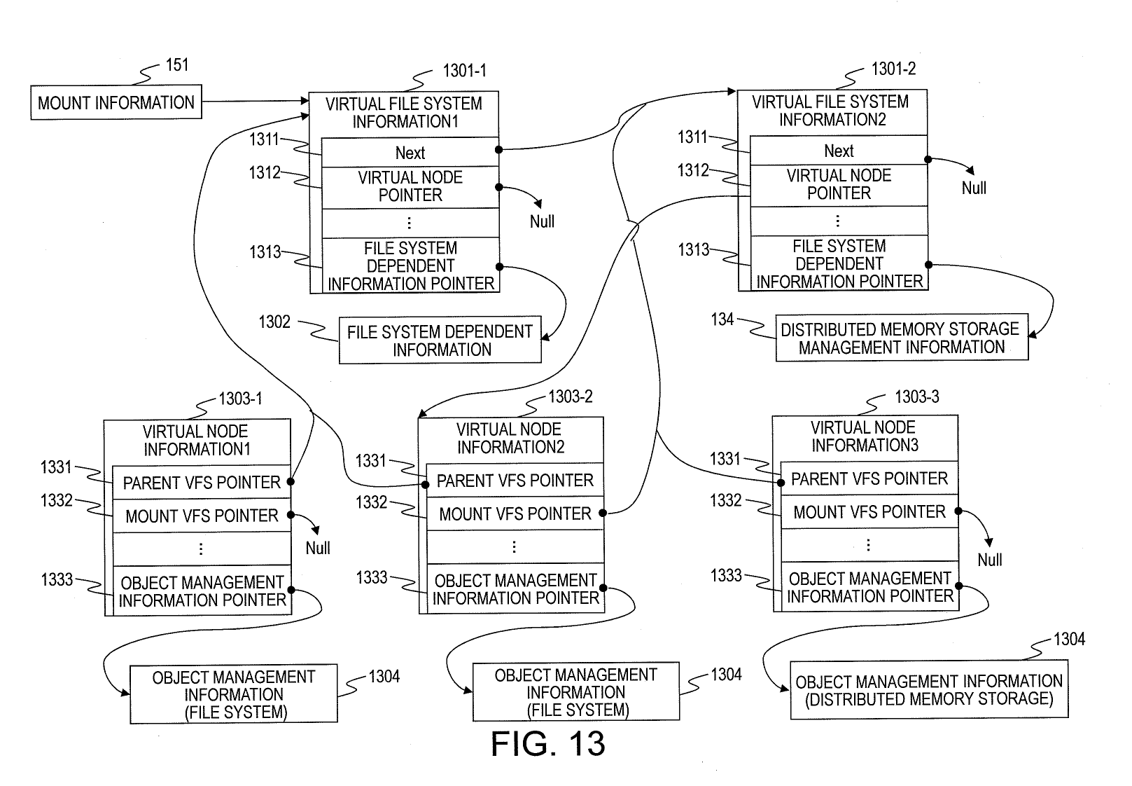

The mount information 151 stores management information on the file system, the directory, the file, and the like that are to be mounted. The mount information 151 is described later in detail with reference to FIG. 13.

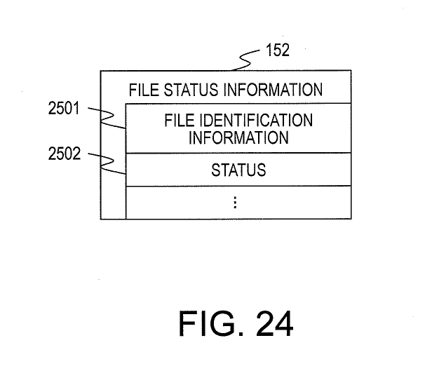

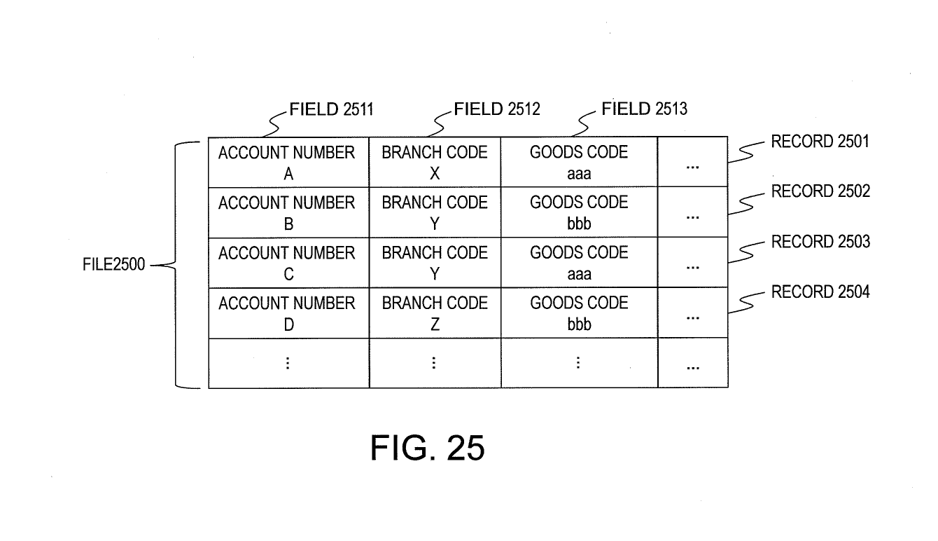

The file status information 152 manages status information on the files stored on the storage device 103 and the distributed memory storage 301 (see FIG. 3). The file status information 152 is described later in detail with reference to FIG. 24.

The server 102 includes a processor 114, a memory 115, and interfaces 116. The processor 114, the memory 115, and the interfaces 116 are coupled to one another by using an internal bus or the like. It should be noted that the server 102 may include another component such as an input/output unit for inputting/outputting information.

The processor 114 executes a program read onto the memory 115, to thereby realize a function provided to the server 102.

The memory 115 stores the program executed by the processor 114 and information necessary to execute the program. Specifically, the memory 115 stores a program for realizing an AP 123, a distributed memory storage access module 124, and a file system access module 125, and also stores local file management information 126.

The AP 123 is an application for accessing the files stored on the storage device 103 and the distributed memory storage 301 (see FIG. 3). In this embodiment, the application is described by using a COBOL language. It should be noted that this invention is not limited to the application described by using the COBOL language. In other words, any program that requests normal input/output may be employed.

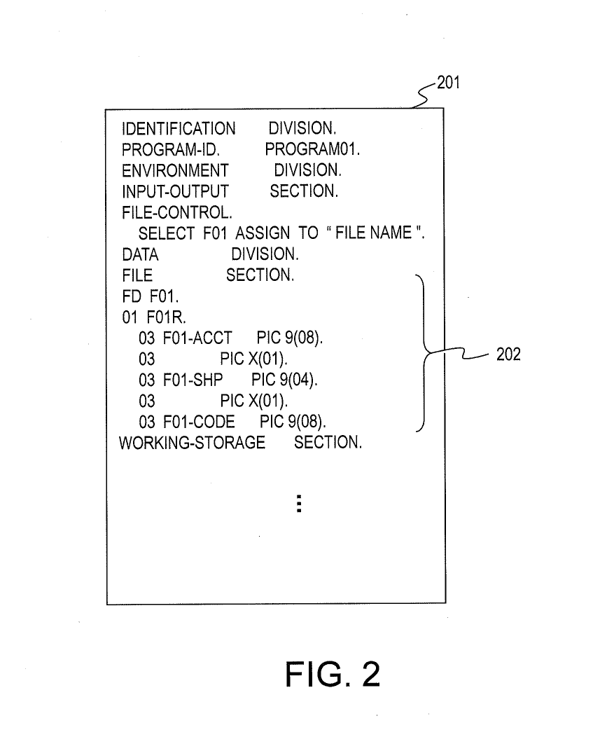

FIG. 2 is an explanatory diagram illustrating an example of a source program of the AP 123 according to the embodiment of this invention.

FIG. 2 illustrates a source program 201 using the COBOL language. A definition of a file structure is described in a FILE SECTION 202 of DATA DIVISION included in the source program 201. Specifically, with regard to the files to be processed by the application, one file is defined by a description item (FD) and at least one record description item.

The description is made again with respect to FIG. 1.

The distributed memory storage access module 124 controls access to the distributed memory storage 301 (see FIG. 3). The file system access module 125 controls access to the file system, and includes an open file information 161.

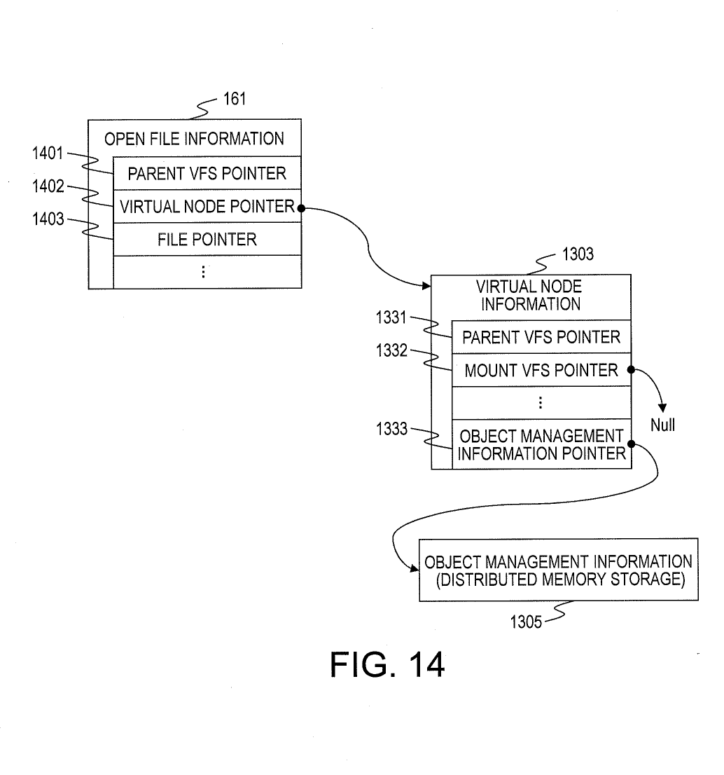

The open file information 161 stores information relating to the file for which open processing has been executed among the files stored on the storage device 103 and the distributed memory storage 301 (see FIG. 3). The server 102 can identify an accessible file by referring to the open file information 161. The open file information 127 is described later in detail with reference to FIG. 14.

In this embodiment, the AP 123 accesses the file stored on the storage device 103 or the distributed memory storage via the file system access module 125.

The local file management information 126 stores information relevant to the plurality of pieces of key-value data stored in the storage area that forms the distributed memory storage 301 (see FIG. 3). In other words, management information on the plurality of pieces of key-value data retained by the server 102 itself is stored.

It should be noted that the configuration realized by the program may be realized by using hardware.

FIG. 3 is an explanatory diagram illustrating a logical configuration example of the distributed memory storage according to the embodiment of this invention.

FIG. 3 illustrates the distributed memory storage 301 obtained by integrating the memory areas of a server 1 (102A), a server 2 (102B), and a server 3 (102C).

The distributed memory storage 301 stores the plurality of pieces of key-value data 302. A key-value data 302 is data having a data structure obtained by combining a key and a value into one. It should be noted that one of the key-value data 302 is also referred to as an “entry” in the following description.

It should be noted that a plurality of distributed memory storages 301 may be generated by integrating the memory areas of the server 1 (102A), the server 2 (102B), and the server 3 (102C). In this case, different key-value data can be stored in the respective distributed memory storages 301.

Alternatively, by integrating the memory areas of the server 1 (102A) and the server 2 (102B) or the memory areas of the server 2 (102B) and the server 3 (102C), the distributed memory storage 301 may be generated in each of the integrated memory areas.

This embodiment is described by using an example of the distributed memory storage 301, but the same storage may be formed by using a plurality of other storage devices.

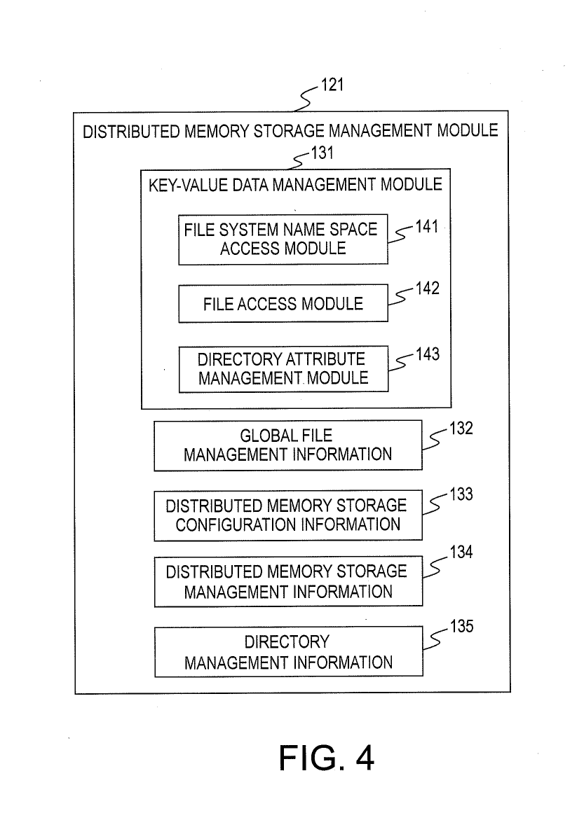

FIG. 4 is an explanatory diagram illustrating details of the distributed memory storage management module 121 and the key-value data management module 131 according to the embodiment of this invention.

The key-value data management module 131 includes a file system name space access module 141, a file access module 142, and a directory attribute management module 143.

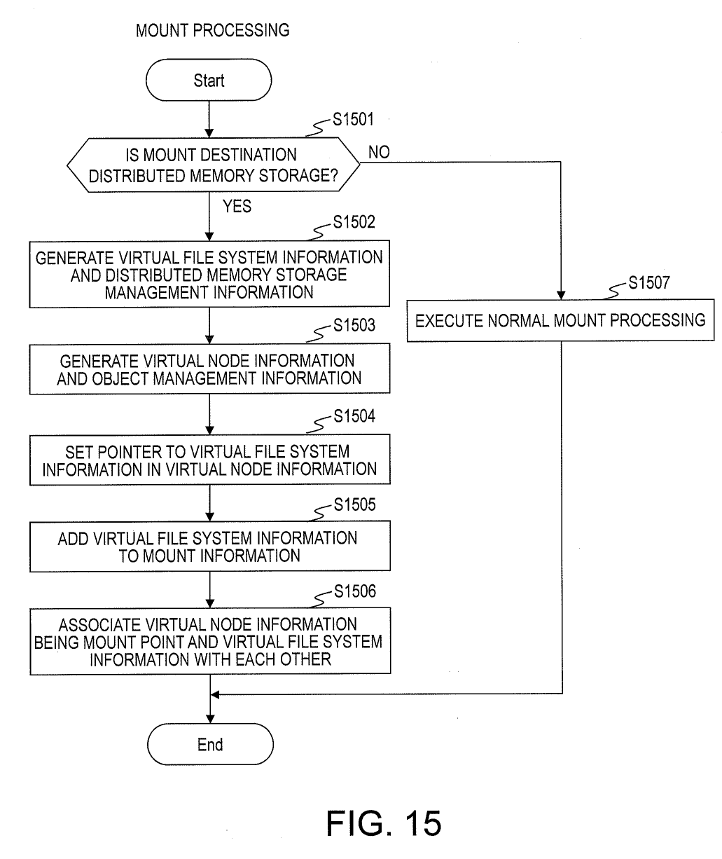

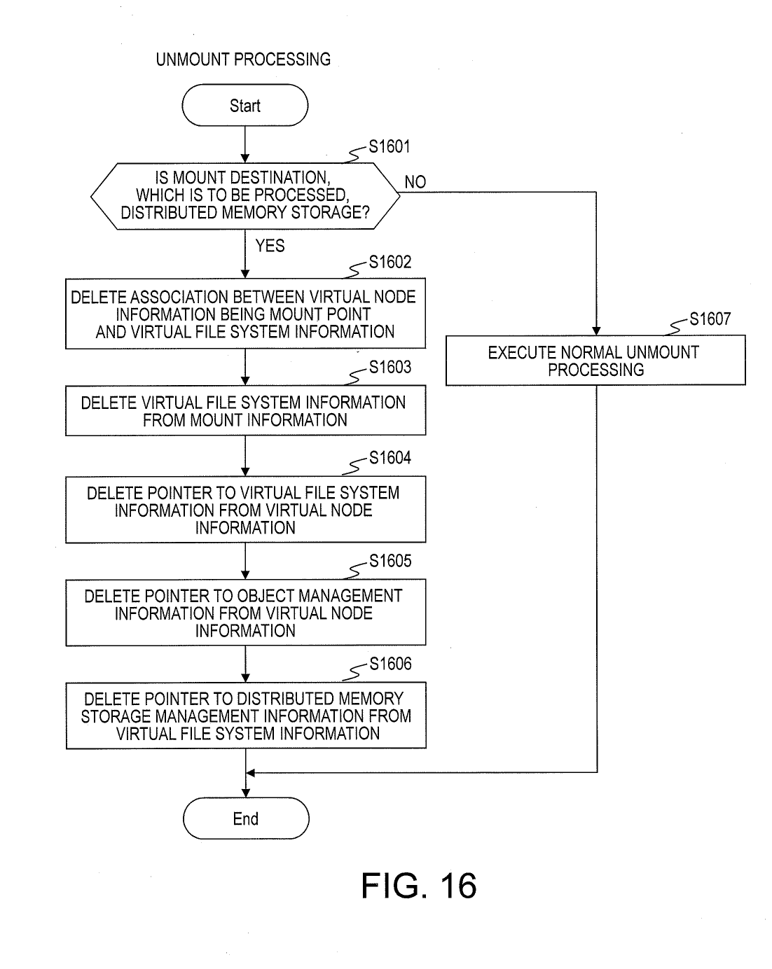

The file system name space access module 141 executes mount processing and unmount processing for the file system. The mount processing and the unmount processing are described later in detail with reference to FIGS. 15 and 16.

The file access module 142 executes file-basis access to the plurality of pieces of key-value data 302 stored on the distributed memory storage 301.

The directory attribute management module 143 executes processing relating to attributes of the directory and the file.

The distributed memory storage management module 121 stores, as management information on the distributed memory storage 301, the global file management information 132, distributed memory storage configuration information 133, distributed memory storage management information 134, and directory management information 135.

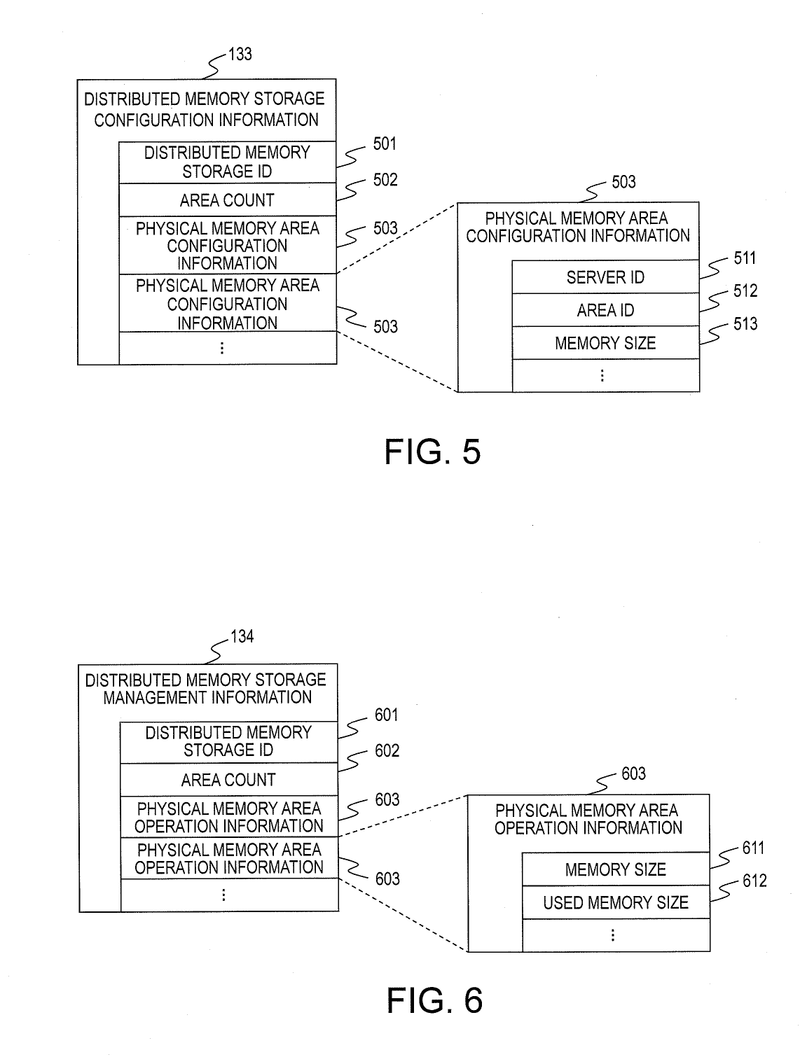

The distributed memory storage configuration information 133 stores information indicating a correlation between the distributed memory storage 301 and the memory areas of the respective servers 102. The distributed memory storage configuration information 133 is described later in detail with reference to FIG. 5.

The distributed memory storage management information 134 stores information relating to a usage status of the distributed memory storage 301. The distributed memory storage management information 134 is described later in detail with reference to FIG. 6.

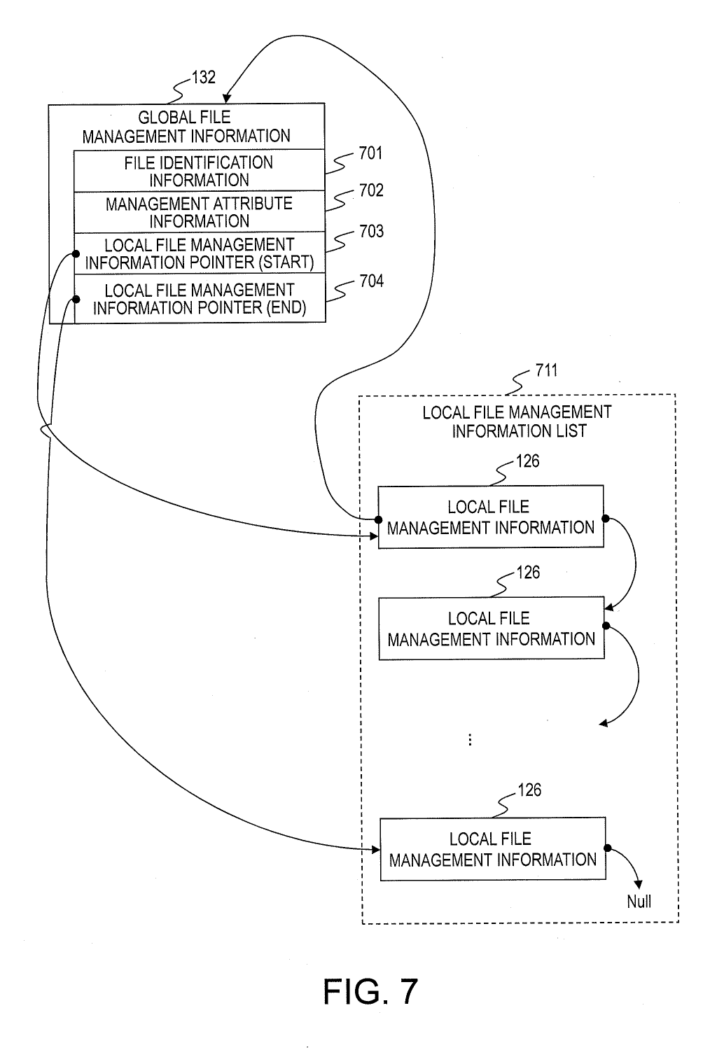

The global file management information 132 stores the information relating to the correlation with local file management information 126. The global file management information 132 is described later in detail with reference to FIG. 7.

In a distributed memory technology using the key-value data, the plurality of pieces of key-value data are placed in the memory areas of the respective servers 102 that form the distributed memory storage 301. For that reason, based on the global file management information 132, the management server 101 can grasp which memory area, in other words, which server 102 the key-value data is placed in.

It should be noted that the global file management information 132 is described later in detail with reference to FIG. 7.

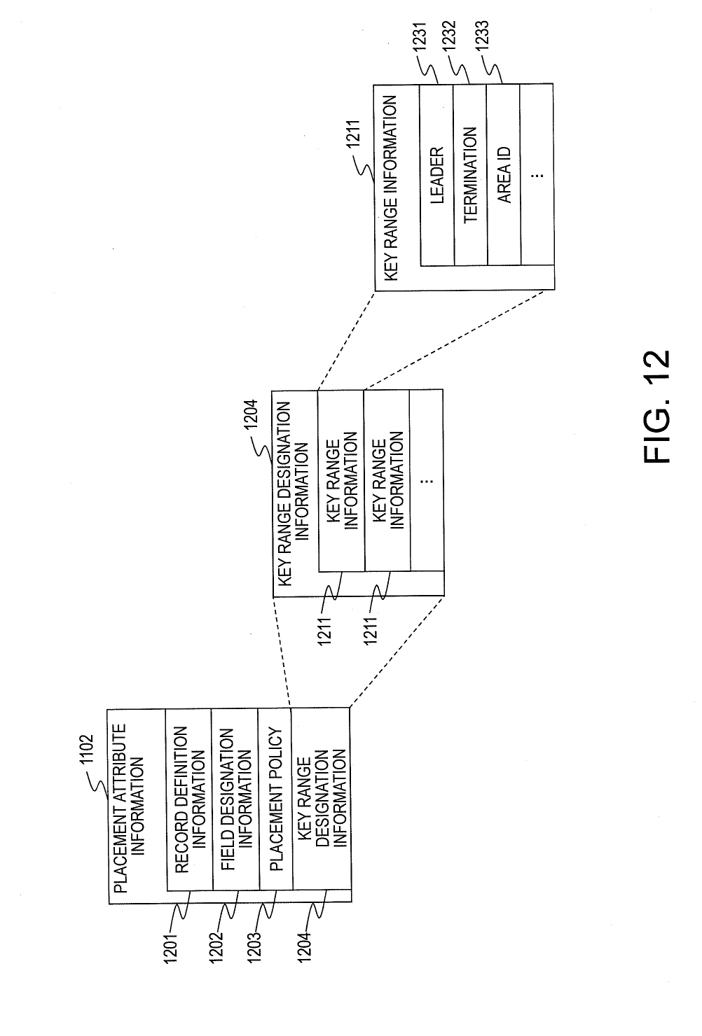

The directory management information 135 stores definition information such as a method of distributing the records stored under a predetermined directory. The directory management information 135 is described later in detail with reference to FIG. 11.

The respective pieces of information are described below.

FIG. 5 is an explanatory diagram illustrating details of the distributed memory storage configuration information 133 according to the embodiment of this invention.

The distributed memory storage configuration information 133 includes a distributed memory storage ID 501, an area count 502, and a plurality of pieces of physical memory area configuration information 503.

The distributed memory storage ID 501 stores an identifier for identifying the distributed memory storage 301 within the computer system.

The area count 502 stores the number of memory areas that form the distributed memory storage 301 corresponding to the distributed memory storage ID 501.

The physical memory area configuration information 503 stores configuration information on the memory areas that form the distributed memory storage 301. Specifically, the physical memory area configuration information 503 includes a server ID 511, an area ID 512, and a memory size 513.

The server ID 511 stores an identifier for identifying the server 102 providing the memory areas that form the distributed memory storage 301. As the server ID 511, any information that can identify the server 102 may be used, and examples thereof may include a host name and an IP address.

The area ID 512 stores an identifier for identifying the memory area within the server 102 in a case where the server 102 retains a plurality of memory areas. As the area ID 512, any information that can identify the server 102 may be used, and examples thereof may include a physical address of the memory 115. It should be noted that a method of using an address of a head of the memory area as the physical address of the memory 115 is conceivable.

The memory size 513 stores information indicating a size of the memory area provided on the distributed memory storage 301.

FIG. 6 is an explanatory diagram illustrating details of the distributed memory storage management information 134 according to the embodiment of this invention.

The distributed memory storage management information 134 includes a distributed memory storage ID 601, an area count 602, and a plurality of pieces of physical memory operation information 603.

The distributed memory storage ID 601 stores an identifier for identifying the distributed memory storage 301 within the computer system. The distributed memory storage ID 601 is the same information as the distributed memory storage ID 501.

The area count 602 stores the number of memory areas that form the distributed memory storage 301 corresponding to the distributed memory storage ID 501. The area count 602 is the same information as the area count 502.

The physical memory operation information 603 stores information indicating the operation status of the memory areas that form the distributed memory storage 301. Specifically, the physical memory operation information 603 includes a memory size 611 and a used memory size 612.

The memory size 611 stores information indicating a size of the memory area provided on the distributed memory storage 301. The memory size 611 is the same information as the memory size 513.

The used memory size 612 stores information indicating the size of the memory area used in actuality among the memory areas provided on the distributed memory storage 301.

FIG. 7 is an explanatory diagram illustrating details of the global file management information 132 according to the embodiment of this invention.

The global file management information 132 includes file identification information 701, management attribute information 702, a local file management information pointer (start) 703, and a local file management information pointer (end) 704.

The file identification information 701 stores identification information for identifying the file. As the file identification information 701, any information that can identify the file may be used, and examples thereof may be a file name and an i-node number.

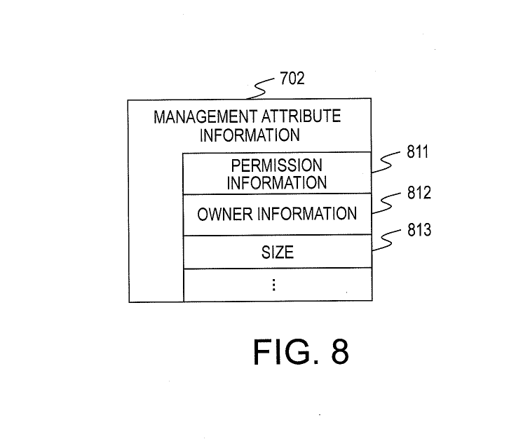

The management attribute information 702 stores management information on the file corresponding to the file identification information 701. The management attribute information 702 is described later in detail with reference to FIG. 8.

The local file management information pointer (start) 703 and the local file management information pointer (end) 704 store pointers to the local file management information 126 retained by the server 102 on which the plurality of pieces key-value data generated by dividing the file corresponding to the file identification information 701 are stored.

In this embodiment, when the plurality of pieces of key-value data are placed, a local file management information list 711 indicating a placement relationship is generated. The local file management information pointer (start) 703 stores an address of the first piece of local file management information 126 within the local file management information list 711. Further, the local file management information pointer (end) 704 stores an address of the last piece of local file management information 126 within the local file management information list 711.

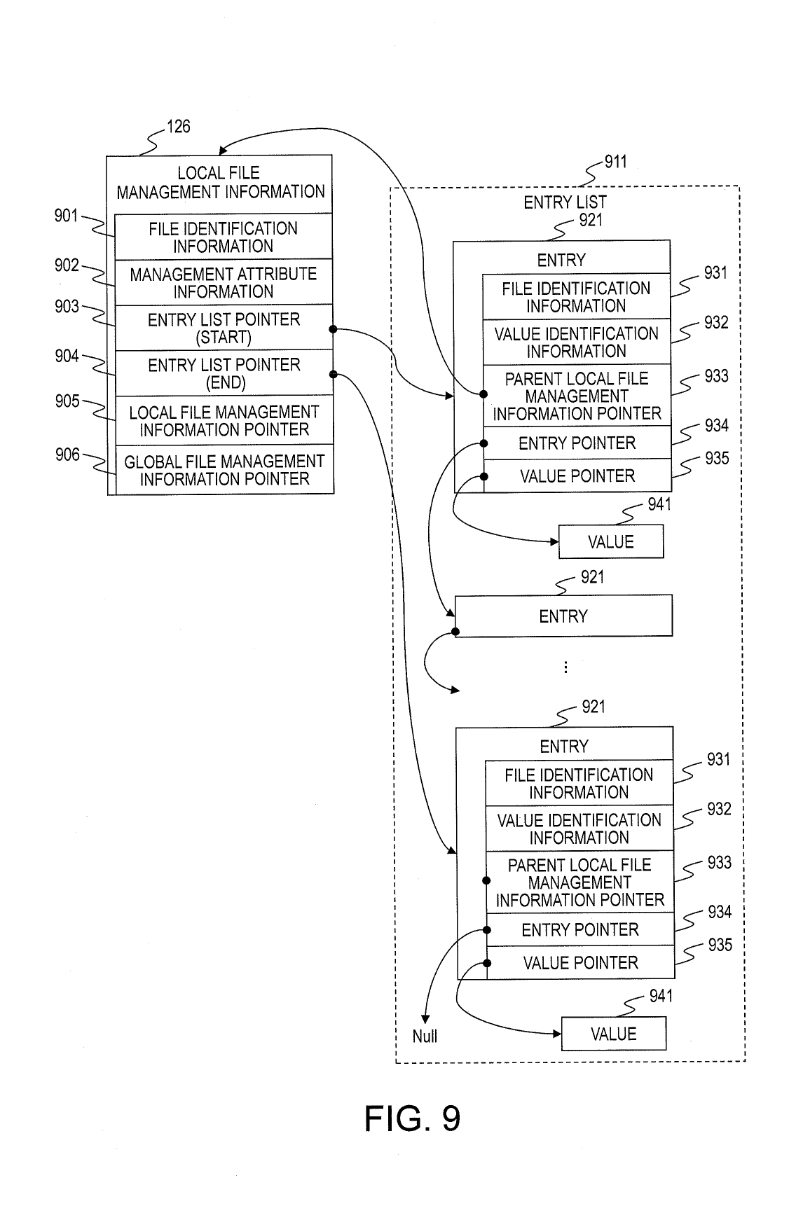

On the other hand, the local file management information 126 includes a local file management information pointer 905 (see FIG. 9) being the pointer to another piece of local file management information 126. As illustrated in FIG. 7, the local file management information pointer 905 (see FIG. 9) stores the pointer so that the pieces of local file management information 126 can be read in an order defined by the local file management information list. Accordingly, it is possible to grasp the server 102 on which the entry (key-value data) is placed.

It should be noted that Null is stored in the local file management information pointer 905 (see FIG. 9) of the last piece of local file management information 126 within the local file management information list 711.

Further, the local file management information 126 includes a global file management information pointer 906 (see FIG. 9).

Accordingly, it is possible to grasp a correlation between the global file management information 132 and the local file management information 126.

It should be noted that the local file management information 126 is described later in detail with reference to FIG. 9.

In this embodiment, in a case where a file I/O including the file identification information 701 is input, by referring to the global file management information 132, the management server 101 can grasp the distributed memory storage 301 on which the plurality of pieces of key-value data are placed. In other words, it is possible to associate the file with the plurality of pieces of key-value data.

FIG. 8 is an explanatory diagram illustrating details of the management attribute information 702 according to the embodiment of this invention.

The management attribute information 702 includes permission information 811, owner information 812, and a size 813. It should be noted that other information may be included.

The permission information 811 stores information on access authority of the file corresponding to the file identification information 701.

The owner information 812 stores information on an owner of the file corresponding to the file identification information 701.

The size 813 stores information indicating a size of the file corresponding to the file identification information 701.

FIG. 9 is an explanatory diagram illustrating details of the local file management information 126 according to the embodiment of this invention.

The local file management information 126 includes file identification information 901, management attribute information 902, an entry list pointer (start) 903, an entry list pointer (end) 904, the local file management information pointer 905, and the global file management information pointer 906.

The file identification information 901 stores identification information for identifying the file. As the file identification information 901, any information that can identify the file may be used, and examples thereof may be a file name and an i-node number. The file identification information 901 is the same information as the file identification information 701.

The management attribute information 902 stores management information on the file corresponding to the file identification information 901. The management attribute information 902 is the same information as the management attribute information 702.

The entry list pointer (start) 903 and the entry list pointer (end) 904 store pointers to entries 921. Here, the entry 921 represents one of the plurality of pieces of key-value data.

In this embodiment, an entry list 911 is created when the key-value data is placed on each server 102. In the entry list 911, the entries 921 are arrayed in the sort order of key information.

The entry list pointer (start) 903 stores a pointer to the first entry 921 included in the entry list 911.

The entry list pointer (end) 904 stores a pointer to the last entry 921 included in the entry list 912.

The local file management information pointer 905 is the pointer to another piece of local file management information 126. Accordingly, by accessing the first piece of local file management information 126, the management server 101 can grasp the local file management information 126 that stores the plurality of pieces of key-value data obtained by dividing the file corresponding to the file identification information 901.

The global file management information pointer 906 stores a pointer to the global file management information 132 for managing the local file management information 126.

Next, the entry 921 is described.

The entry 921 includes file identification information 931, value identification information 932, a parent local file management information pointer 933, an entry pointer 934, and a value pointer 935.

The file identification information 931 stores identification information on the file. As the file identification information 931, any information that can identify the file may be used, and examples thereof may be a file name and an i-node number. The file identification information 931 is the same information as the file identification information 701.

The value identification information 932 stores identification information on the field included in the record that forms the file. As the value identification information 932, any information that can identify the field may be used, and examples thereof may include a name of the field.

The parent local file management information pointer 933 stores a pointer to the local file management information 126 to which the entry 921 belongs.

The entry pointer 934 stores the pointer to another entry 921. As illustrated in FIG. 9, the entry pointer 934 stores the pointer so that the entries 921 can be read in an order defined by the entry list 911.

It should be noted that Null is stored in the entry pointer 934 of the last entry 921 of the entry list 911. Accordingly, the last entry 921 of the entry list 911 can be identified.

The value pointer 935 stores the pointer to the memory area that stores a value 941 corresponding to details of actual data.

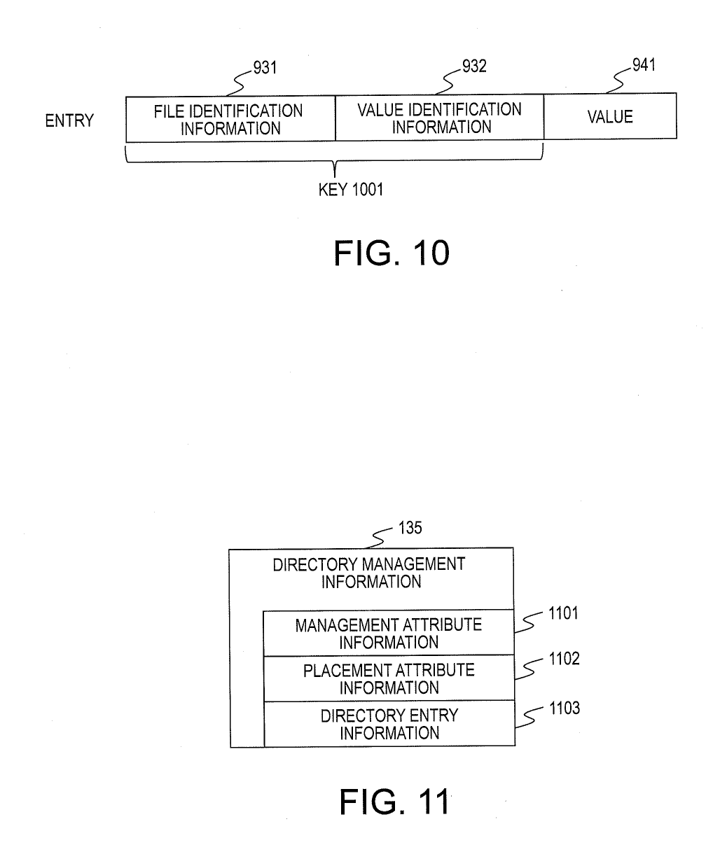

FIG. 10 is an explanatory diagram illustrating a logical configuration example of the entry 921 according to the embodiment of this invention.

As illustrated in FIG. 10, the entry 921 is recognized as a combination of a key 1001 and the value 941.

In this embodiment, the key 1001 is formed of the file identification information 931 and the value identification information 932.

FIG. 11 is an explanatory diagram illustrating details of the directory management information 135 according to the embodiment of this invention.

The directory management information 135 includes management attribute information 1101, placement attribute information 1102, and directory entry information 1103.

The management attribute information 1101 stores management information on the directory. The management attribute information 1101 includes the same information as the management attribute information 702.

The placement attribute information 1102 stores information relevant to a placement method for the plurality of pieces of key-value data stored under the directory. The placement attribute information 1102 is described later in detail with reference to FIG. 12.

The directory entry information 1103 stores the identification information such as the name of the file stored under the directory.

FIG. 12 is an explanatory diagram illustrating details of the placement attribute information 1102 according to the embodiment of this invention.

The placement attribute information 1102 includes record definition information 1201, field designation information 1202, a placement policy 1203, and key range designation information 1204.

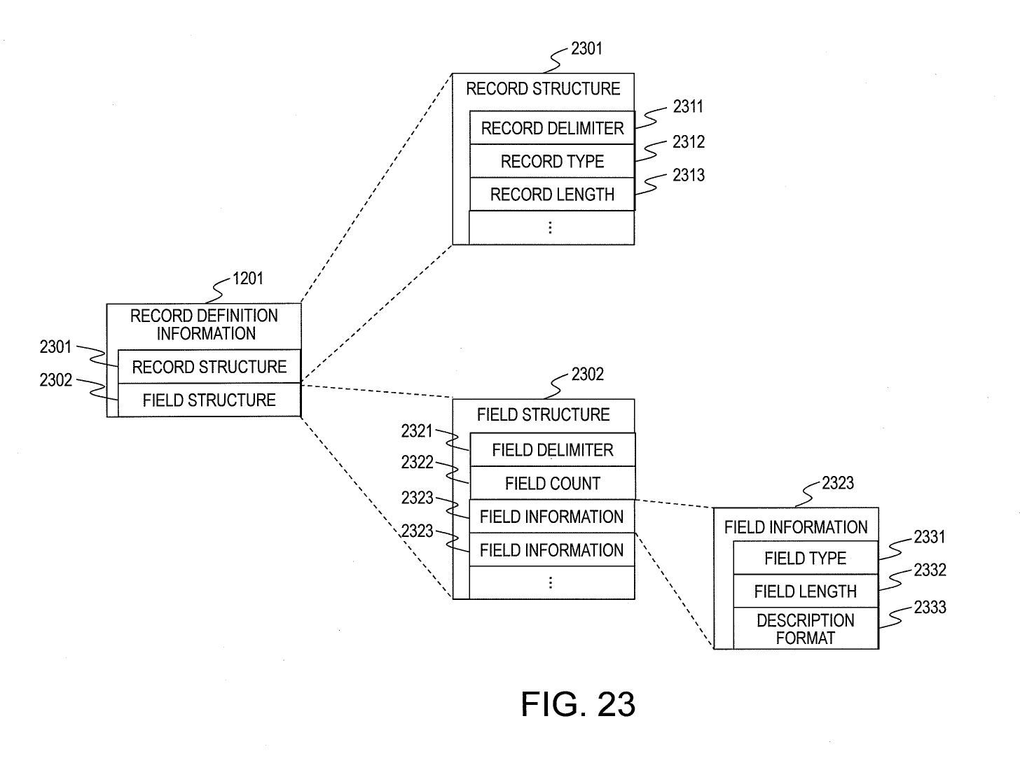

The record definition information 1201 stores information relating to a structure of the record that forms the file. The record definition information 1201 is described later in detail with reference to FIG. 23.

The field designation information 1202 stores information on the field corresponding to the value identification information 932 that forms the key 1001. In this embodiment, the plurality of pieces of key-value data are generated based on the field designated by the field designation information 1202.

The placement policy 1203 stores information relating to the placement method for the plurality of pieces of key-value data on the server 102 that forms the distributed memory storage 301.

Possible examples of the placement method for the key-value data include a method of equally placing (leveling) the plurality of pieces of key-value data pieces on the respective servers 102 and a method of placing the plurality of pieces of key-value data for each designated key range. It should be noted that the placement attribute information 1102 is not limited to the above-mentioned methods, and this invention may employ any placement method to produce the same effects.

The key range designation information 1204 stores information relating to the key range for placing the plurality of pieces of key-value data on the respective servers 102. It should be noted that in a case where the placement policy 1203 stores information indicating the leveling, the key range designation information 1204 is not used.

The key range designation information 1204 further includes key range information 1211.

The key range information 1211 stores information relating to a range of a key for placing the plurality of pieces of key-value data on the respective servers 102. Specifically, the key range information 1211 includes a leader 1231, a termination 1232, and an area ID 1233.

The leader 1231 stores information on the key 1001 to be a start point of the key range. The termination 1232 stores information on the key 1001 to be an end point of the key range.

The area ID 1233 stores an identifier for identifying the memory area within the server 102 in the case where the server 102 retains a plurality of memory areas. The area ID 1233 is the same information as the area ID 512.

FIG. 23 is an explanatory diagram illustrating details of the record definition information 1201 according to the embodiment of this invention.

The record definition information 1201 is information used in a case where the management server 101 recognizes the record of the file and divides the file on a record-to-record basis. The record definition information 1201 includes a record structure 2301 and a field structure 2302. It should be noted that in this embodiment, the record definition information 1201 is set for each of the files or the directories that are stored on the distributed memory storage 301.

The record structure 2301 is information for identifying a record structure within the file, and includes a record delimiter 2311, a record type 2312, and a record length 2313.

The record delimiter 2311 stores information indicating a character code for delimiting the records. As the record delimiter 2311, for example, the character code indicating a line break may be used.

The record type 2312 stores information indicating which of a fixed length record and a variable length record the record within the file is.

For example, in a case where the record type 2312 stores information indicating the fixed length record, the records that form the file are records all having the same length. On the other hand, in a case where the record type 2312 stores information indicating the variable length record, the records that form the file are records having different lengths from each other.

In the case where the record type 2312 stores information indicating the fixed length record, the record length 2313 stores information indicating a length of one record.

It should be noted that as long as the record structure 2301 includes the information that can identify the structure of the record, there is no need to include the information of all of the record delimiter 2311, the record type 2312, and the record length 2313. For example, in a case of the fixed length record, the record delimiter 2311 may not be included in the record structure 2301.

The record structure 2302 is information for identifying a field within the record, and includes a field delimiter 2321, a field count 2322, and field information 2323.

The field delimiter 2321 stores information indicating a character code for delimiting the fields. As the field delimiter 2321, for example, the character code indicating a space may be used.

The field information 2323 is information relating to data recorded in the corresponding field, and includes a field type 2331, a field length 2332, and a description format 2333. It should be noted that one piece of field information 2323 exists for one field.

In the case where the record type 2311 stores the information indicating the variable length record, the field type 2331 stores information indicating which of a variable length field and a fixed length field the corresponding field is.

In a case where the field type 2331 stores information indicating the fixed length field, the field length 2332 stores a magnitude of a field length of the corresponding field, and in a case where the field type 2331 stores information indicating the variable length field, the field length 2332 stores the size of the area that stores information indicating the “field length” of the corresponding field.

The description format 2333 stores information indicating description format, such as ASCII or binary, of the data recorded in the corresponding field.

It should be noted that as long as the field structure 2302 can identify the field within the record, there is no need to include the information of all of the field delimiter 2321, the field count 2322, and the field information 2323. For example, as long as the field length 2332 of the field information 2323 is designated, there is no need to include the field delimiter 2321 in the field structure 2302.

In a case where the file is formed of the fixed length records, the individual record can be recognized by a value set in the record length 2312. On the other hand, in a case where the file is formed of the variable length record, each record has a field for recording a size of the record set at a head thereof, and the management server 101 can recognize a delimiter of the record based on information of the field.

In the case where the file is formed of the variable length records, the management server 101 can identify the first field from the information set in the field structure 2302 and obtain a record size. After recognizing the record, the management server 101 refers to the field count 2321 and a field size 2322 of the field structure 2302 to identify the field.

It should be noted that the record definition information 1201 can have any format as long as the format can define the record and the field of the file. For example, it is possible to use the definition of the file structure described in the FILE SECTION 202 of DATA DIVISION included in the source program 201 as illustrated in FIG. 2.

FIG. 13 is an explanatory diagram illustrating details of the mount information 151 according to the embodiment of this invention.

In this embodiment, a virtual file system (VFS) is used in order to convert an abstracted operation (such as read or write) performed for the file by the application into an operation dependent on the individual file system. Accordingly, the application can access the storage media having different file systems by the same operation. It should be noted that the virtual file system is described in, for example, S. R. Klieman, “Vnode: An Architecture for Multiple File System Types in Sun UNIX”, 1986, USENIX Summer 1986 Technical Conference, pp. 238-247.

In the virtual file system, a list of virtual file system information 1301 exists, and the mount information 151 stores the list.

The virtual file system information 1301 includes a Next 1311, a virtual node pointer 1312, and a file system dependent information pointer 1313. It should be noted that the virtual file system information 1301 includes other information of a known technology, which is omitted.

The Next 1311 stores the pointer to another piece of virtual file system information 1301. Accordingly, all the pieces of virtual file system information 1301 included in the list can be followed.

The virtual node pointer 1312 stores a pointer to virtual node information 1303 be mounted (virtual node at a mount point).

The file system dependent information pointer 1313 stores a pointer to file system dependent information 1302 or the distributed memory storage management information 134.

In this embodiment, at least one piece of virtual file system information 1301 is associated with the distributed memory storage management information 134.

The virtual node information 1303 stores management information on the file or the directory. The virtual node information 1303 includes a parent VFS pointer 1331, a mount VFS pointer 1332, and an object management information pointer 1333. It should be noted that the virtual node information 1303 includes other information of a known technology, which is omitted.

The parent VFS pointer 1331 stores a pointer to the virtual file system information 1301 corresponding to the virtual file system to which the virtual node belongs.

The mount VFS pointer 1332 stores a pointer to the virtual node information 1303 being the mount point.

The object management information pointer 1333 stores a pointer to object management information 1304.

Here, the object management information 1304 is management information on the file or the directory dependent on a predetermined file system. In this embodiment, the object management information 1304 dependent on the distributed memory storage 301 includes the local file management information 126, the global file management information 132, and directory management information 144.

In the example of FIG. 13, the mount information 151 points to virtual file system information 1 (1301-1), which is a root file system. The Next 1311 of the virtual file system information 1 (1301-1) stores a pointer to a virtual file system 2 (1301-2). Further, the file system dependent information pointer 1313 of the virtual file system information 1 (1301-1) stores a pointer to the file system dependent information 1302. It should be noted that the virtual file system information 1 (1301-1) is the root file system and does not have a virtual node to be mounted, and hence the virtual node pointer 1312 stores a pointer to Null.

In the example of FIG. 13, no virtual file system information 1301 other than the virtual file system information 2 (1301-2) exists, and hence the Next 1311 stores the pointer to Null. Further, the file system dependent information pointer 1313 of the virtual file system information 2 (1301-2) stores the pointer to the distributed memory storage management information 134. Further, the virtual file system information 2 (1301-2) is mounted for virtual node information 2 (1303-2), and hence the virtual node pointer 1312 stores a pointer to the virtual node information 2 (1303-2).

In the example of FIG. 13, virtual node information 1 (1303-1) belongs to the virtual file system information 1 (1301-1), and hence the parent VFS pointer 1331 stores a pointer to the virtual file system information 1 (1301-1). Further, the object management information pointer 1333 of the virtual node information 1 (1303-1) stores the pointer to the object management information 1304 relating to a predetermined file system. It should be noted that none of the pieces of virtual file system information 1301 is mounted for the virtual node information 1 (1303-1), and hence the mount VFS pointer 1332 stores the pointer to Null.

In the example of FIG. 13, virtual node information 2 (1303-2) belongs to the virtual file system information 1 (1301-1), and hence the parent VFS pointer 1331 stores a pointer to the virtual file system information 1 (1301-1). Further, the virtual node information 2 (1303-2) is the directory being the mount point, and hence the mount VFS pointer 1332 stores a pointer to the virtual file system information 2 (1301-2). Further, the object management information pointer 1333 of the virtual node information 2 (1303-2) stores the pointer to the object management information 1304 relating to the predetermined file system.

In the example of FIG. 13, virtual node information 3 (1303-3) belongs to the virtual file system information 2 (1301-2), and hence the parent VFS pointer 1331 stores a pointer to the virtual file system information 2 (1301-2). Further, the object management information pointer 1333 of the virtual node information 1 (1303-1) stores the pointer to the object management information 1305 relating to the distributed memory storage 301. It should be noted that none of the pieces of virtual file system information 1301 is mounted for the virtual node information 3 (1303-3), and hence the mount VFS pointer 1332 stores the pointer to Null.

FIG. 14 is an explanatory diagram illustrating details of the open file information 161 according to the embodiment of this invention.

The open file information 161 includes a parent VFS pointer 1401, a virtual node pointer 1402, and a file pointer 1403.

The parent VFS pointer 1401 stores the pointer to the virtual file system information 1301 to which the file system for managing the file for which the open processing has been executed belongs.

The virtual node pointer 1402 stores the pointer to the virtual node information 1303 that stores management information on the file for which the open processing has been executed.

Here, the virtual node information 1303 is the same as the virtual node information illustrated in FIG. 13, and the object management information pointer 1333 of the virtual node information 1303 stores, as object management information 1305, any one of the pointer to the local file management information 126 and the pointer to the global file management information 132.

The file pointer 1403 stores a processing position of the data on the file to be subjected to read processing or write processing.

FIG. 24 is an explanatory diagram illustrating an example of the file status information 152 according to the embodiment of this invention.

The file status information 152 includes file identification information 2401 and a status 2402.

The file identification information 2401 stores the identification information for identifying the file. The file identification information 2401 is the same as the file identification information 701.

The status 2402 stores a processing status or the like of the file. For example, information such as “reading” is stored in a case where the read processing is being executed for the file, and information such as “writing” is stored in a case where the write processing is being executed for the file. Further, the identification information or the like on the server 102 being an access source may be included.

FIG. 15 is a flowchart illustrating the mount processing according to the embodiment of this invention.

In a case of receiving a mount command from an operator of the management server 101, the management server 101 reads the file system name space access module 141, and starts the following processing. It should be noted that a processing trigger is not limited thereto, and the processing may be started when, for example, the mount command is received from the AP 123 of the server 102.

The file system name space access module 141 refers to the received mount command to determine whether a mount destination is the distributed memory storage 301 (Step S1501).

In a case where it is determined that the mount destination is not the distributed memory storage 301, in other words, in a case where it is determined that the storage device 103 is the mount destination, the file system name space access module 141 executes a normal mount operation (Step S1507), and finishes the processing. It should be noted that the mount processing of Step S1507 is a known technology, and therefore a description thereof is omitted.

In a case where it is determined that the mount destination is the distributed memory storage 301, the file system name space access module 141 generates the virtual file system information 1301 and the distributed memory storage management information 134 (Step S1502).

At this time, the pointer to the generated distributed memory storage management information 134 is set in the generated virtual file system information 1301. Specifically, the pointer to the generated distributed memory storage management information 134 is set in the file system dependent information pointer 1313 of the generated virtual file system information 1301.

Subsequently, the file system name space access module 141 generates the virtual node information 1303 and the object management information 1304 (Step S1503).

At this time, the pointer to the generated object management information 1304 is set in the generated virtual node information 1303. Specifically, the pointer to the generated object management information 1304 is stored in the object management information pointer 1333 of the generated virtual node information 1303.

The file system name space access module 141 sets the pointer to the generated virtual file system information 1301 in the generated virtual node information 1303 (Step S1504). Specifically, the pointer to the generated virtual file system information 1301 is stored in the parent VFS pointer 1331 of the generated virtual node information 1303.

The file system name space access module 141 adds the generated virtual file system information 1301 to the mount information 151 (Step S1505).

Specifically, the pointer to the generated virtual file system information 1301 is stored in the Next 1311 of the last piece of virtual file system information 1301 of the list within the mount information 151. Further, Null is stored in the Next 1311 of the generated virtual file system information 1301.

By the processing of Steps S1502 to S1505, the information on the file system to be mounted is generated.

The file system name space access module 141 associates the generated virtual file system information 1301 and the virtual node information 1303 being the mount point with each other (Step S1506), and finishes the processing.

Specifically, the pointer to the virtual node information 1303 being the mount point is stored in the virtual node pointer 1312 of the generated virtual file system information 1301. Further, the pointer to the generated virtual file system information 1301 is stored in the mount VFS pointer 1332 of the virtual node information 1303 being the mount point.

FIG. 16 is a flowchart illustrating the unmount processing according to the embodiment of this invention.

In a case of receiving an unmount command from the operator of the management server 101, the management server 101 reads the file system name space access module 141, and starts the following processing. It should be noted that a processing trigger is not limited thereto, and the processing may be started when, for example, the unmount command is received from the AP 123 of the server 102.

The file system name space access module 141 refers to the received unmount command to determine whether or not a mount destination of the virtual file system information 1301 to be subjected to the unmount processing is the distributed memory storage 301 (Step S1601).

The virtual file system information 1301 to be subjected to the unmount processing is hereinafter also referred to as “subject virtual file system information 1301”.

At this time, the file system name space access module 141 identifies the mount point of the subject virtual file system information 1301 based on the received unmount command. Accordingly, the virtual node information 1303 being the mount point can be identified.

In a case where it is determined that the mount destination of the subject virtual file system information 1301 is not the distributed memory storage 301, in other words, in a case where it is determined that the storage area on the storage device 103 is the mount destination of the subject virtual file system information 1301, the file system name space access module 141 executes a normal unmount operation (Step S1607), and finishes the processing. It should be noted that the unmount processing of Step S1607 is a known technology, and therefore a description thereof is omitted.

In a case where it is determined that the mount destination of the subject virtual file system information 1301 is the distributed memory storage 301, the file system name space access module 141 deletes association between the virtual node information 1303 being the mount point and the subject virtual file system information 1301 (Step S1602).

Specifically, the pointer to the virtual node information 1303 being the mount point is deleted from the virtual node pointer 1312 of the subject virtual file system information 1301. Further, the pointer to the subject virtual file system information 1301 is deleted from the mount VFS pointer 1332 of the virtual node information 1303 being the mount point.

The file system name space access module 141 deletes the subject virtual file system information 1301 from the mount information 151 (Step S1603). Specifically, the following processing is executed.

First, the file system name space access module 141 identifies the virtual file system information 1301 that stores the pointer to the subject virtual file system information 1301 from the virtual file system information 1301 included in the list within the mount information 151. In addition, the file system name space access module 141 deletes the pointer to the subject virtual file system information 1301 from the Next 1311 of the identified virtual file system information 1301.

Subsequently, the file system name space access module 141 deletes the pointer to the subject virtual file system information 1301 from the virtual node information 1303 that stores the pointer to the subject virtual file system information 1301 (Step S1604). Specifically, the pointer to the subject virtual file system information 1301 is deleted from the parent VFS pointer 1331 of the virtual node information 1303.

The file system name space access module 141 deletes the pointer to the object management information 1304 from the virtual node information 1303 from which the pointer to the subject virtual file system information 1301 is deleted (Step S1605). Specifically, the pointer to the subject object management information 1304 is deleted from the object management information pointer 1333 of the virtual node information 1303.

It should be noted that the file system name space access module 141 may delete the virtual node information 1303 and the object management information 1304, or may leave the virtual node information 1303 and the object management information 1304 as they are for reuse thereof.

The file system name space access module 141 deletes the pointer to the distributed memory storage management information 134 from the subject virtual file system information 1301 (Step S1606). Specifically, the pointer to the distributed memory storage management information 134 is deleted from the file system dependent information pointer 1313 of the subject virtual file system information 1301.

It should be noted that the file system name space access module 141 may delete the subject virtual file system information 1301 and the distributed memory storage management information 134, or may leave the subject virtual file system information 1301 and the distributed memory storage management information 134 as they are for reuse thereof.

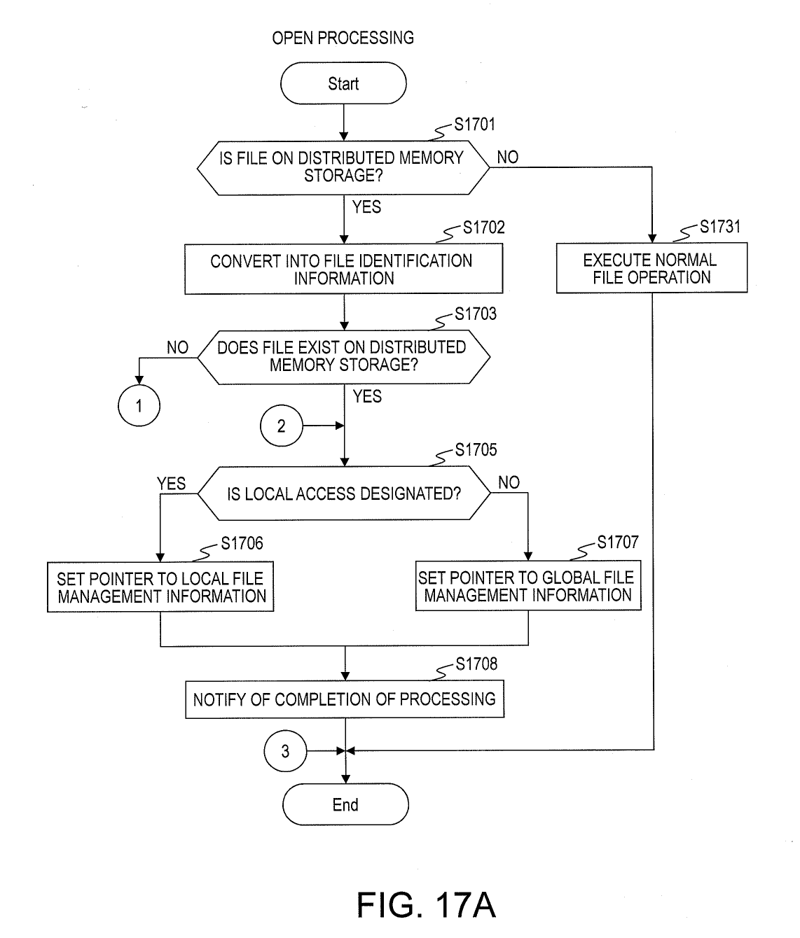

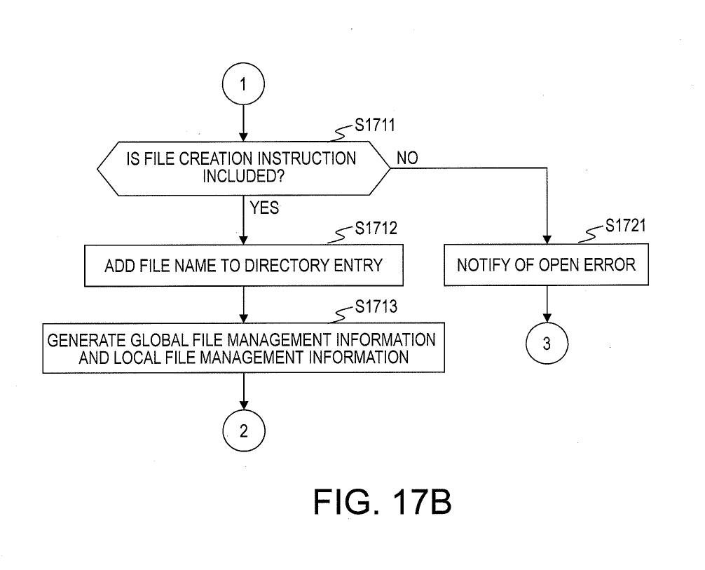

FIGS. 17A and 17B are flowcharts illustrating the open processing according to the embodiment of this invention.

In a case of receiving an access request (such as read request or write request) from the AP 123, the file system access module 125 starts the open processing. Further, at this time, the file system access module 125 transmits an execution request for the open processing to the management server 101. The execution request includes at least the name of the file to be processed.

The file system access module 125 that has transmitted the execution request for the open processing executes normal open processing. Specifically, the open file information 161 is initialized to set the necessary pointers in the open file information 161.

In the initialization processing, the pointer to the virtual file system information 1301 on the file system to be mounted in the directory in which a subject file exists is stored in the parent VFS pointer 1401 of the open file information 161. Further, the pointer to the virtual node information 1303 that stores the management information on the subject file is stored in the virtual node pointer 1402.

Further, in the open processing, the pointer to any one of the local file management information 126 and the global file management information 132 is set in the object management information pointer 1333 relating to the open file information 161.

The above-mentioned information is acquired by the management server 101 and transmitted to the file system access module 125. A description is now made of processing performed by the management server 101 that has received the execution request for the open processing.

In a case of receiving the execution request for the open processing including the name of the file to be processed, the management server 101 calls the file system management module 122 to start the following processing. The file whose file name is designated is also referred to as “subject file” in the following description.

It should be noted that any one of an absolute path and a relative path may be used as the file name included in the execution request for the open processing.

The management server 101 determines whether the subject file is stored on the distributed memory storage 301 based on the file name included in the execution request for the open processing (Step S1701).

Specifically, in a case where the file name is a relative path name, the management server 101 converts the relative path name into the absolute path. Subsequently, the management server 101 refers to the mount information 151 based on an absolute path name to determine whether or not the distributed memory storage 301 is mounted in the directory in which the subject file is stored. More specifically, the following processing is executed.

First, the management server 101 refers to the absolute path name to follow the list of the virtual file system information 1301 stored in the mount information 151 based on a directory name included in the absolute path name and determine whether or not the mount point to the virtual node information 1303 exists.

In a case where it is determined that the mount point to the virtual node information 1303 exists, the management server 101 refers to the mount VFS pointer 1332 of the virtual node information 1303 indicated by the mount point to identify the virtual file system information 1301 being the mount destination. Further, the management server 101 refers to the object management information 1304 corresponding to the virtual node information 1303 indicated by the mount point to identify the virtual node information 1303 to be mounted in the directory in which the subject file is stored.

Subsequently, the management server 101 refers to the parent VFS pointer 1331 of the identified virtual node information 1303 to identify the virtual file system information 1301 to which the identified virtual node information 1303 belongs.

In addition, the management server 101 refers to the file system dependent information pointer 1313 of the identified virtual file system information 1301 to determine whether or not the pointer to the distributed memory storage management information 134 is stored.

In a case where the file system dependent information pointer 1313 stores the pointer to the distributed memory storage management information 134, it is determined that the subject file is stored on the distributed memory storage 301.

This is the end of the processing of Step S1701.

In a case where the subject file is not stored on the distributed memory storage 301, in other words, in a case where it is determined that the subject file is stored on the storage device 103, the management server 101 executes a normal open processing (Step S1731), and finishes the processing. It should be noted that the open processing of Step S1731 is a known technology, and therefore a description thereof is omitted.

In a case where it is determined that the subject file is stored on the distributed memory storage 301, the management server 101 reads the distributed memory storage management module 121, and executes the following processing.

In a case where it is determined that the subject file is stored on the distributed memory storage 301, the management server 101 converts the absolute path name into file identification information within the distributed memory storage 301 (Step S1702).

It is possible to use the i-node number as the file identification information. However, in a case where the file system differs, the i-node number may overlap. For that reason, the i-node number may be used along with information for identifying the file system (including distributed memory storage) or information for identifying the device.

For example, in the case of the distributed memory storage, it is possible to use a distributed memory storage ID 601 of the distributed memory storage management information 134. Further, as the file identification information, the absolute path name may be used as it is because a purpose thereof is to enable the file to be identified.

The management server 101 refers to the directory management information 135 corresponding to the directory identified in Step S1701 to determine whether the subject file exists on the distributed memory storage 301 (Step S1703).

Specifically, the management server 101 refers to the directory entry information 1103 of the directory management information 135 to identify the directory that stores the subject file in accordance with a format defined on the distributed memory storage 301 and search for the file name of the subject file. In a case where the directory entry information 1103 stores the file name of the subject file, it is determined that the subject file exists on the distributed memory storage 301.

By the above-mentioned processing, the pointer to the virtual file system information 1301 stored in the parent VFS pointer 1401 of the open file information 161 and the pointer to the virtual node information 1303 stored in the virtual node pointer 1402 are identified. The management server 1010 transmits the information on each of the above-mentioned pointers to the file system access module 125. The file system access module 125 that has received the information on the pointer sets the pointer in the open file information 161.

Subsequently, the management server 101 refers to the file name included in the execution request for the open processing to determine whether local access is designated (Step S1705).

Here, the local access represents access performed only to the local file management information 126 corresponding to the subject file. For example, in a case where the plurality of pieces of key-value data obtained by dividing a file A are placed on each of a server A and a server B, in a case where the server A requests for access to the file A by designating the local access, access is performed only to the plurality of pieces of key-value data (local file management information 126) of the file A stored on the server A.

As a method of designating the local access, there may be a method of including the identification information for designating the local access in the file name. For example, in a case of designating the local access for the file whose file name is “/X/A”, “/X/A.local” is included in the execution request for the open processing. It should be noted that this invention is not limited thereto, and there may be used a method of imparting the identification information for designating the local access separately from the file name.

The management server 101 can determine whether or not the local access is designated by determining presence/absence of the above-mentioned identification information for designating the local access.

In a case where it is determined that the local access is designated, the management server 101 sets the pointer to the local file management information 126 in the object management information pointer 1333 of the virtual node information 1303 that stores the pointer to the open file information 161 (Step S1706).

Specifically, the management server 101 transmits a response including the pointer to the local file management information 126 to the distributed memory storage access module 124. Accordingly, the distributed memory storage access module 124 can access only to the plurality of pieces of key-value data stored in the local file management information 126 within the subject file.

In a case where it is determined that the local access is not designated, the management server 101 sets the pointer to the global file management information 132 in the object management information pointer 1333 of the virtual node information 1303 within the open file information 161 (Step S1707).

Specifically, the management server 101 transmits a response including the pointer to the global file management information 132 to the distributed memory storage access module 124. The received information is notified of from the distributed memory storage access module 124 to the file system access module 125, and the pointer is set in the open file information 161.

By the processing of Steps S1704 to S1707, the necessary information is set in the open file information 161.

After that, the management server 101 notifies the server 102 that has transmitted the execution request for the open processing that the processing has been completed (Step S1708), and finishes the processing.

The file system access module 125 that has received the notification imparts a file descriptor to the file for which the open processing has been executed. Further, the management server 101 generates management information (not shown) obtained by associating the file descriptor with the pointer to the open file information 161 corresponding to the file for which the open processing has been executed. The file system access module 125 executes the file access by using the file descriptor from then on.

On the other hand, in a case where it is determined in Step S1703 that the subject file does not exist on the distributed memory storage 301, the management server 101 determines whether a file creation instruction is included in the execution request for the open processing (Step S1711).

In a case where it is determined that the file creation instruction is not included in the execution request for the open processing, the management server 101 notifies the server 102 that has transmitted the execution request for the open processing of an open error (Step S1721), and finishes the processing.

In a case where it is determined that the file creation instruction is included in the execution request for the open processing, the management server 101 stores the file name included in the execution request for the open processing in the directory entry information 1103 of the directory management information 135 (Step S1712).

Specifically, the identification information obtained by converting the file name is stored. It should be noted that the directory management information 135 can be identified based on the file name included in the file creation instruction. For example, in a case where the file name included in the file creation instruction is “/W/X/A”, the management server 101 can grasp that the file is stored under the directory “/W/X” and identify the directory management information 135 corresponding to the directory.

Subsequently, the management server 101 generates the global file management information 132 and the local file management information 126 based on the placement attribute information 1102 of the directory management information 135 (Step S1713).

Specifically, the following processing is executed.

First, the management server 101 stores the identification information whose file name has been converted in the file identification information 701 of the global file management information 132, and sets the necessary information in the management attribute information 702 of the global file management information 132.

Subsequently, based on the placement policy 1203 and the key range designation information 1204, the management server 101 determines the placement of the pieces of local file management information 126 onto the respective servers 102 that form the distributed memory storage 301, and generates the local file management information 126. At this time, the local file management information list 711 is also generated. It should be noted that the distributed memory storage configuration information 133 is referred to in the case where the placement of the pieces of local file management information 126 is determined. Accordingly, the servers 102 that form the distributed memory storage 301 can be grasped, and the placement method with respect to the respective servers 102 can be determined.

Based on the generated local file management information list 711, the management server 101 stores the pointers in the local management information pointer (start) 703 and the local management information pointer (end) 704.

In addition, the management server 101 stores the same identification information as the file identification information 701 in the file identification information 901 of the local file management information 126, stores the same information as the management attribute information 702 in the management attribute information 902, and stores the pointer to the global file management information 132, to which the local file management information 126 belongs, in the global file management information pointer 906. Further, based on the generated local file management information list 711, the management server 101 stores the pointer corresponding to the local file management information pointer 905.

After that, the management server 101 transmits the generated local file management information 126 to the respective servers 102 based on the determined placement.

The above-mentioned processing enables the management server 101 to grasp a correlation between the file identification information such as the file name and the key-value data.

It should be noted that this invention is not limited to the above-mentioned processing. For example, the server 102 may execute the processing of Step S1701, Step S1702, and the like. In this invention, any processing may be performed as long as the management server 101 and the server 102 can cooperate to generate the open file information 161.

A description is now made of processing for the access request received from the AP 123.

After the open processing is completed, first, the access request is processed by the file system access module 125.

First, the file system access module 125 determines whether or not access is performed to the distributed memory storage 301.

For example, in the case where the object management information pointer 1333 stores the pointer to the local file management information 126 or the global file management information 132, it is determined that the access is performed to the distributed memory storage 301.

In a case where it is determined that the access is performed to the distributed memory storage 301, the file system access module 125 calls the distributed memory storage access module 124, and the distributed memory storage access module 124 executes the following processing.

A description is now made of the access to the distributed memory storage 301.

In a case where the access request is the read request, the distributed memory storage access module 124 determines whether or not the read request is performed for the local file management information 126 of itself.

Specifically, the distributed memory storage access module 124 determines whether or not the pointer to the local file management information 126 is stored in the object management information pointer 1333 relating to the open file information 161. In a case where the pointer to the local file management information 126 is stored in the object management information pointer 1333, it is determined that the read request is performed for the local file management information 126 of itself.

In a case where it is determined that the read request is performed for the local file management information 126 of itself, the distributed memory storage access module 124 reads the data of the file based on the local file management information 126 of itself, and finishes the processing.

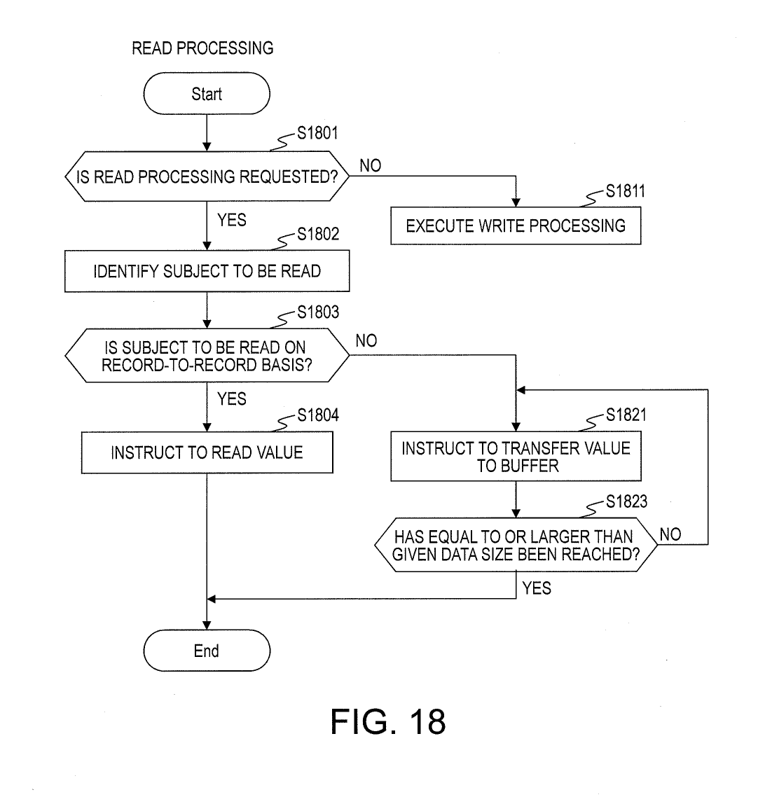

In a case where it is determined that the read request is not performed for the local file management information 126 of itself, the distributed memory storage access module 124 requests the management server 101 for the read processing. The management server 101 that has received the request executes the processing illustrated in FIG. 18.

In a case where the access request is the write request, the distributed memory storage access module 124 determines whether or not the write request is performed for the local file management information 126 of itself.

Specifically, the distributed memory storage access module 124 determines whether or not the pointer to the local file management information 126 is stored in the object management information pointer 1333 relating to the open file information 161.

In a case where it is determined that the write request is performed for the local file management information 126 of itself, the distributed memory storage access module 124 writes the data of the file based on the local file management information 126 of itself, and finishes the processing.

In the write processing for data, for example, the following processing is executed. The distributed memory storage access module 124 creates the plurality of pieces of key-value data based on the file identification information 901 of the local file management information 126. In addition, the distributed memory storage access module 124 adds the entries corresponding to the created plurality of pieces of key-value data to the entry list 911, and further updates the local file management information 126. After that, the distributed memory storage access module 124 transmits the updated local file management information 126 to the management server 101.

It should be noted that this invention is not limited to the write processing for data. Any method that can create the key-value data may be employed.

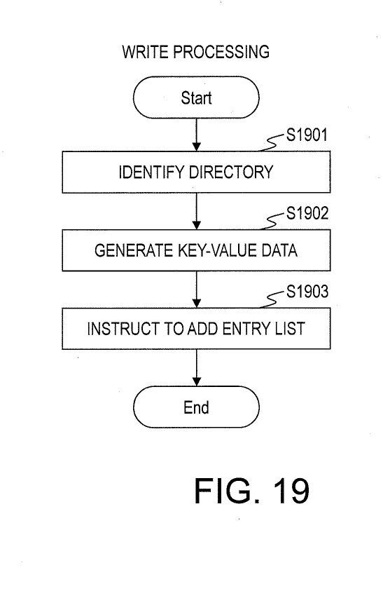

In a case where it is determined that the write request is not performed for the local file management information 126 of itself, the distributed memory storage access module 124 requests the management server 101 for the write processing. The management server 101 that has received the request executes the processing illustrated in FIG. 19.

Next, the read processing and the write processing performed on the distributed memory storage 301 are described with reference to FIGS. 18 and 19.

A description is now made of processing performed by the management server 101 in a case of receiving the access request to the distributed memory storage 301 from the server 102 after the open processing.

FIG. 18 is a flowchart illustrating the read processing performed on the distributed memory storage 301 according to the embodiment of this invention.

In a case of receiving the access request to the distributed memory storage 301 from the server 102, the management server 101 determines whether the access request is the read request (Step S1801).

Specifically, the management server 101 refers to a function included in the access request to determine whether or not the access request is the read request.

It should be noted that the determination processing may be executed by the file system access module 125 of the server 102 or the like. In this case, the management server 101 receives a determination result from the server 102.

In a case where it is determined that the access request is not the read request, in other words, in a case where it is determined that the access request is the write request, the management server 101 executes the write processing (Step S1811). The write processing is described later with reference to FIG. 19.

In a case where it is determined that the access request is the read request, the management server 101 identifies the file to be subjected to the read processing (Step S1802).

Specifically, the management server 101 identifies the file based on the pointer to the global file management information 132 designated by the server 102. It should be noted that the server 102 identifies the pointer to the global file management information 132 by the following processing.

The server 102 identifies the open file information 161 based on the file descriptor. Subsequently, the server 102 identifies the virtual node information 1303 based on the identified open file information 161. In addition, the server 102 refers to the object management information pointer 1333 within the virtual node information 1303 to identify the pointer to the global file management information 132.

At this time, the management server 101 updates the file status information 152. Specifically, the identification information on the file to be processed is stored in the file identification information 2501, and information indicating that the read processing is being executed is stored in the status 2502.

Subsequently, the management server 101 determines whether the read processing is to be performed on a record-to-record basis (Step S1803).

Examples of a method of designating the record-to-record-basis reading may include a method of using a function for reading record-to-record-basis information and a method of including a flag or the like for designating the record-to-record-basis reading in the access request.

By referring to the function used for the access request or the flag or the like included in the access request, the management server 101 can determine whether or not the read processing is to be performed on a record-to-record basis. It should be noted that the determination processing may be executed by the file system access module 125 of the server 102 or the like. In this case, the management server 101 receives the determination result from the server 102.

In a case where it is determined that the read request is performed on a record-to-record-basis, the management server 101 reads the data (value) of the file to be read on a record-to-record basis based on the global file management information 132 or the local file management information 126 (Step S1804).

Specifically, the management server 101 issues an instruction to read the value 941 to the server 102 retaining the entry 921. The server 102 that has received the instruction reads the value 941 from the designated entry 921, and transmits the read value 941 to the server 102 being the request source.

The server 102 that has received the data updates the file pointer 1403 of the open file information 161. Specifically, the pointer corresponding to the read value 941 is stored in the file pointer 1403. Accordingly, it is possible to grasp progress in reading the data of the file to be read.

The management server 101 executes the same processing until all the data pieces (values) of the file to be read are read.

In a case where it is determined in Step S1803 that the read request is not performed on a record-to-record-basis, the management server 101 stores the data (value) of the file to be read in a buffer (not shown) based on the global file management information 132 (Step S1821).

It should be noted that when the read request is not performed on a record-to-record-basis, a request size of the data to be read is included in the access request.

At this time, the value 941 is read from a position indicated by the file pointer 1403 within a range that does not exceed the request size, and the read value 941 is stored in the buffer (not shown).

The management server 101 determines whether equal to or larger than a given data size has been reached (Step S1823).

Specifically, it is determined whether or not any one of the following conditions is satisfied: a condition that data (value) corresponding to the request size has been read; and a condition that data (value) having equal to or larger than a predetermined threshold value has been read into the buffer. In a case where any one of the conditions is satisfied, it is determined that equal to or larger than the given data size has been reached.

In a case where it is determined that the given data size has not been reached, the management server 101 returns to Step S1821 to execute the same processing (Steps S1821 to S1823).

In a case where it is determined that the given data size has been reached, the management server 101 transmits the data (value) stored in the buffer to the server 102.

It should be noted that the server 102 that has received the data updates the file pointer 1403 of the open file information 161.

FIG. 19 is a flowchart illustrating the write processing performed on the distributed memory storage 301 according to the embodiment of this invention.

In a case where the access request is the write request in Step S1801 of FIG. 18, the management server 101 executes the following processing. It should be noted that the write request includes the file name.

The management server 101 determines the directory being a write destination for data based on the file name of a subject to be written (Step S1901).

Specifically, the following processing is executed.

First, the management server 101 included in the access request refers to the absolute path name to follow the list of the virtual file system information 1301 stored in the mount information 151 based on the directory name included in the absolute path name and identify the directory in which the file is placed. Accordingly, the directory management information 135 corresponding to the directory can be identified.

Further, the management server 101 refers to the object management information pointer 1333 of the virtual node information 1303 to acquire the pointer to the global file management information 132.

Based on the placement attribute information 1102 of the directory management information 135 and the global file management information 132, the management server 101 determines the server 102 for placing the local file management information 126 to which the entry 921 is to be added.

By the above-mentioned processing, the write destination for data is determined.

Subsequently, the management server 101 generates the plurality of pieces of key-value data from the data to be written based on the directory management information 135 (Step S1902).

Specifically, the management server 101 generates the plurality of pieces of key-value data based on the record definition information 1201 and the field designation information 1202 of the placement attribute information 1102, and sorts the generated plurality of pieces of key-value data.

The management server 101 instructs the server 102 being the write destination to add the generated plurality of pieces of key-value data to the local file management information 126 (Step S1903).

Each server 102 that has received the instruction generates the entries whose number corresponds to the number of the plurality of pieces of key-value data, and sets the necessary information in the file identification information 931, the value identification information 932, and the parent local file management information pointer 933 of the entry 921. Subsequently, each server 102 stores the pointer to one of the generated plurality of pieces of key-value data (value 941) in the value pointer 935.

In addition, the server 102 adds the entries 921 to the entry list 911 in the sort order. At this time, the entry list pointer 904 is updated. It should be noted that in a case where the file is generated for the first time, the pointer is stored also in the entry list pointer 903.

It should be noted that in a case where record-to-record-basis writing is not designated at a time of writing, the following processing may be executed.

First, the management server 101 acquires record-to-record-basis data from the buffer based on the record definition information 1201 of the placement attribute information 1102.

The management server 101 generates keys and values based on the field designation information 1202 of the placement attribute information 1102, and sorts the plurality of pieces of key-value data based on the record definition information 1201.

The management server 101 generates the entries 921 based on the generated plurality of pieces of key-value data, and adds the generated entries 921 to the entry list 911 in the sort order. At this time, the management server 101 notifies the server 102 of progress in the writing.

The server 102 that has received the notification updates the file pointer 1403 of the open file information 161. Specifically, the pointer corresponding to the written data is stored in the file pointer 1403. Accordingly, it is possible to grasp the progress in writing the data of the file to be written.

The management server 101 determines whether or not equal to or larger than the given data size has been reached.

Specifically, it is determined whether or not any one of the following conditions is satisfied: a condition that the data (value) corresponding to the request size has been written; and a condition that the data (value) having equal to or larger than the predetermined threshold value has been written into the buffer. In a case where any one of the conditions is satisfied, it is determined that equal to or larger than the given data size has been reached.

In a case where it is determined that the given data size has not been reached, the management server 101 executes the same processing as the above-mentioned processing.

In a case where it is determined that the given data size has been reached, the management server 101 writes the data stored in the buffer to the distributed memory storage 301.

It should be noted that examples of a method of designating the record-to-record-basis writing may include a method of using a function for writing the record-to-record-basis information and a method of including a flag or the like for designating the record-to-record-basis writing in the access request. By referring to the function used for the access request or the flag or the like included in the access request, the management server 101 can determine whether or not the write processing is to be performed on a record-to-record basis.

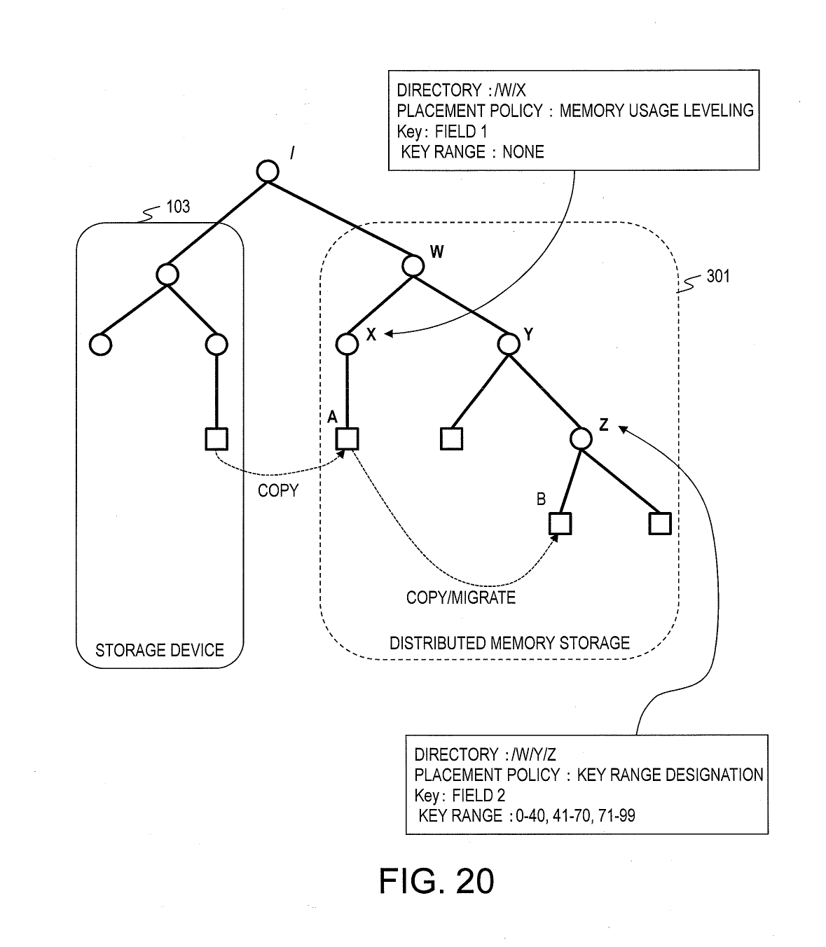

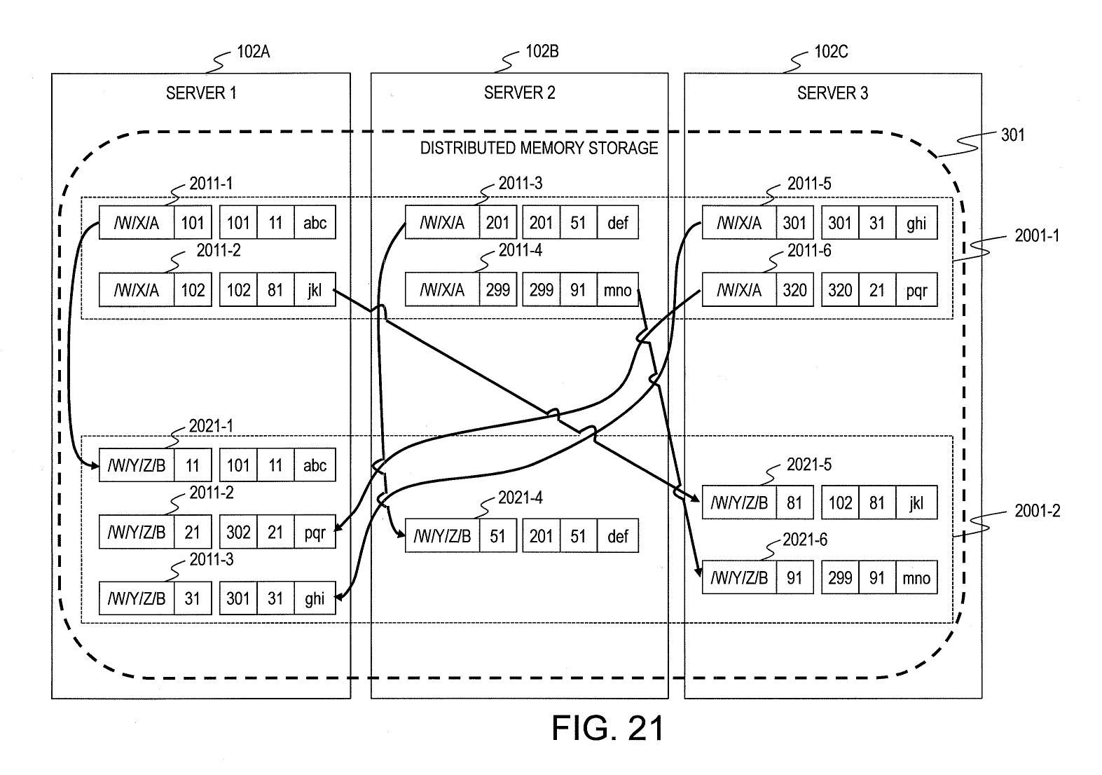

Next, an example to which this invention is applied is described with reference to FIGS. 20 and 21.

FIG. 20 is an explanatory diagram illustrating an example of a directory structure according to the embodiment of this invention.

As illustrated in FIG. 20, respective directories are placed under a root directory “/” in a hierarchical manner. As illustrated in FIG. 20, the directory placed on the storage device 103 and the directory placed on the distributed memory storage 301 are included. The directories and the files under the directory “/W” are placed on the distributed memory storage 301.

A description is made of processing performed in a case where a copy request for copying the file stored in the storage device 103 to the distributed memory storage 301 is received from the server 102. It should be noted that the copy request includes the file name of a copy source and the file name of a copy destination. Further, it is assumed that the local access is not designated. Further, it is assumed that the open processing has been executed for the file on the storage device 103.

At this time, in a case of receiving the copy request from the server 102, the management server 101 executes the open processing (see FIGS. 17A and 17B) on the distributed memory storage 301.

At this time point, the file having the file name “/W/X/A” does not exist on the distributed memory storage 301, and hence the management server 101 executes processing for creating the file under the directory “/W/X” (Steps S1712 and S1713). At this time, the management server 101 determines the placement method for the entry or the like based on the directory management information 135 corresponding to the directory “/W/X”.

Accordingly, with regard to the server 102, there is no need to be aware of the placement method that differs depending on the directory and a structure of the key-value data, and the structure of the key-value data, the placement method for the key-value data, and the like are automatically determined by inputting the file name.

In addition, the management server 101 sets the pointer to the global file management information 132, and returns the file descriptor to the server 102 (Steps S1707 and S1708).

Subsequently, as illustrated in FIG. 19, the management server 101 executes the write processing in order to store the data of the file stored on the storage device 103 onto the distributed memory storage 301.

At this time, based on the directory management information 135 corresponding to the directory “/W/X”, the management server 101 generates the plurality of pieces of key-value data from the data of the file stored on the storage device 103, and transmits the generated plurality of pieces of key-value data to each server 102 based on the determined placement method. The server 102 that has received the plurality of pieces of key-value data sets necessary data in the entry 921.

In the example of FIG. 20, a placement policy for the directory “/W/X” is memory usage leveling, and a field 1 is used as the key. Further, the key range is not designated.

By the above-mentioned processing, the file is copied from the storage device 103 to the distributed memory storage 301.

Next, a description is made of processing performed in a case where the copy request for copying, or a migration request for migrating, the file having the file name of “/W/X/A” from the server 102 to a location under “/W/Y/Z” is received. It should be noted that the copy request and the migration request both include the file name of the copy source and the file name of the copy destination. Further, it is assumed that the local access to “/W/X/A” is not designated.

In order to read file data, as illustrated in FIGS. 17A and 17B, the management server 101 executes the open processing for the file having the file name of “/W/X/A”. At this time, the file having the file name of “/W/X/A” exists on the distributed memory storage 301, and hence the processing of Steps S1707 and S1708 is executed.

Further, in order to write the read entry 921, the management server 101 executes the open processing for the file having the file name of “/W/Y/Z/B” (see FIGS. 17A and 17B). At this time point, the file having the file name “/W/Y/Z” does not exist on the distributed memory storage 301, and hence the management server 101 executes processing for creating the file under the directory “/W/Y/Z” (Steps S1712 to S1713). At this time, the management server 101 determines the placement method for the entry or the like based on the directory management information 135 corresponding to the directory “/W/Y/Z”.

In the example of FIG. 20, the placement policy for the directory “/W/Y/Z” is key range designation, and a field 2 is used as the key. Further, “0-40, 41-70, 71-99” is designated as the key range. In the case of the distributed memory storage 301 as illustrated in FIG. 3, the plurality of pieces of key-value data whose value of the field 2 is “0-40” are stored on the server 1 (102A), the plurality of pieces of key-value data whose value of the field 2 are “41-70” is stored on the server 2 (102B), and the plurality of pieces of key-value data whose value of the field 2 are “71-99” are stored on the server 3 (102C).

Accordingly, with regard to the AP 123, there is no need to be aware of the placement method that differs depending on the directory and the structure of the key-value data, and the structure of the key-value data, the placement method for the key-value data, and the like are automatically determined by inputting the file name.

In a case where the open processing is finished, the management server 101 then executes the read processing in order to read file data pieces of the file having the file name of “/W/X/A” (see FIG. 18). In addition, the management server 101 executes the write processing in order to write the read data to the file having the file name of “/W/Y/Z/B” (see FIG. 19).

At this time, in Step S1903, based on the directory management information 135 corresponding to the directory “/W/Y/Z”, the plurality of pieces of key-value data (entries 921) under the directory “/W/Y/Z” are generated from the key-value data under the directory “/W/X/A”. In addition, based on the directory management information 135 corresponding to the directory “/W/Y/Z”, the generated plurality of pieces of key-value data (entries 921) are placed on the distributed memory storage 301.

FIG. 21 is an explanatory diagram illustrating a placement example of the key-value data in a case where the data of the file is copied between directories according to the embodiment of this invention.

A file 2001-1 represents the file having the file name of “/W/X/A” in FIG. 20.

The placement policy for the directory “/W/X/” is the memory usage leveling, and hence a plurality of pieces of key-value data 2011-1 to 2011-6 that form the file 2001-1 are equally placed on the respective servers 102.

A file 2001-2 represents the file having the file name of “/W/Y/Z/B” in FIG. 20.

The placement policy for the directory “/W/Y/Z/” is the key range designation, and hence a plurality of pieces of key-value data pieces 2021-1 to 2021-6 that form the file 2001-2 are placed on the respective servers 102 based on the key range.

Here, the key-value data 2011-1 in the directory “/W/X” has the key formed of “/W/X/A” and “101” and has the values of “101”, “11”, and “abc”. Further, the key-value data 2021-1 in the directory “/W/Y/Z” has the key formed of “/W/Y/Z/B” and “11” and has the values of “101”, “11”, and “abc”.

As illustrated in FIG. 21, in a case where the file is copied or migrated from the directory “/W/X” to the directory “/W/Y/Z”, a relationship indicated by the arrow is obtained.

The key-value data 2011-1 corresponds to the key-value data 2021-1, the key-value data 2011-2 corresponds to the key-value data 2021-5, the key-value data 2011-3 corresponds to the key-value data 2021-4, the key-value data 2011-4 corresponds to the key-value data 2021-6, the key-value data 2011-5 corresponds to the key-value data 2021-3, and the key-value data 2011-6 corresponds to the key-value data 2021-2.

By the above-mentioned processing, the file can be copied or migrated between the directories on the distributed memory storage 301.

As described above, with regard to the server 102, there is no need to designate the key that differs depending on the directory, the placement method for the key-value data, and the like, and it suffices to designate only the file name. In other words, the AP 123 can execute a file operation on the distributed memory storage 301 by using a normal file interface. This enables the data on the distributed memory storage 301 to be operated without using the AP 123 corresponding to the structure of the key-value data. In other words, there is no need to elaborate the AP 123 for each of the plurality of pieces of key-value data.

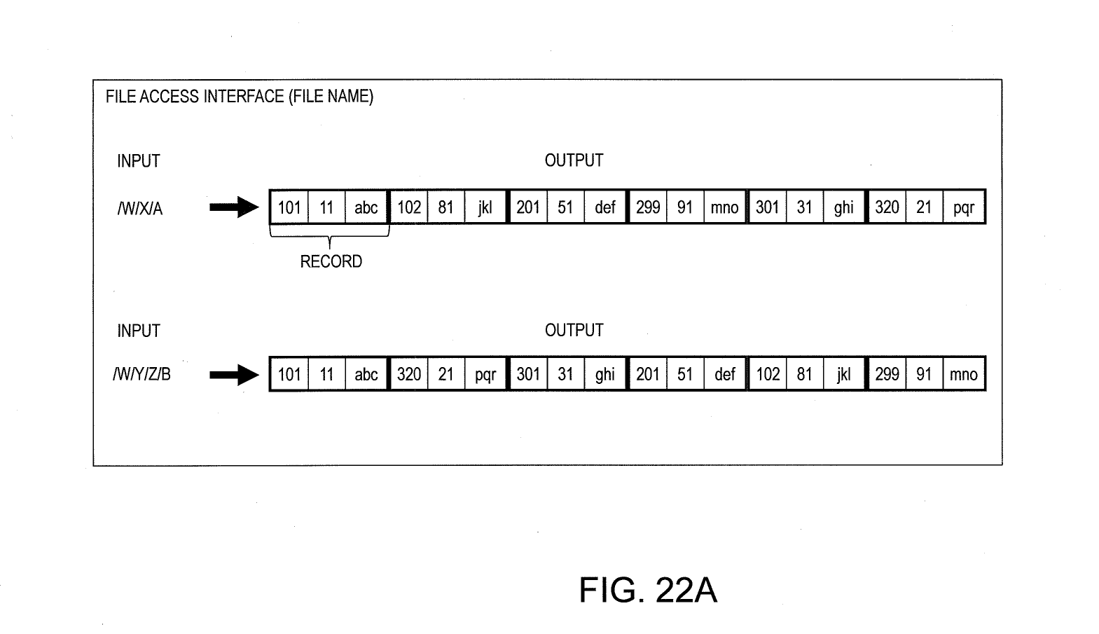

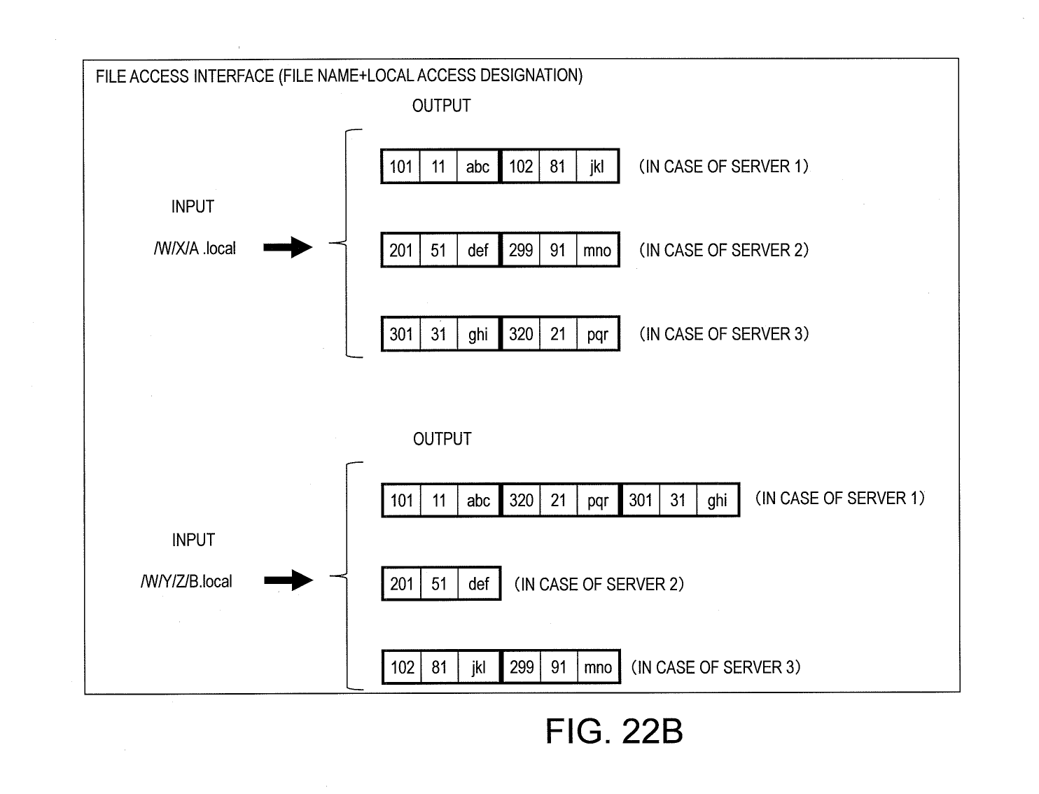

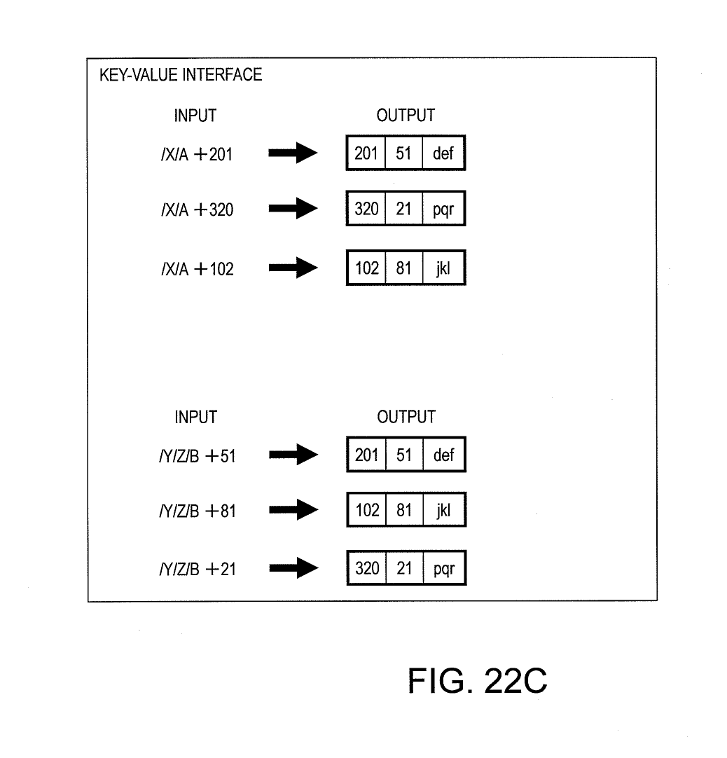

FIGS. 22A, 22B, and 22C are explanatory diagrams illustrating a correspondence between an input from the server 102 and a response from the management server 101 according to the embodiment of this invention.

FIG. 22A is a diagram illustrating the response returned from the management server 101 in a case where the AP 123 designates the file name.

As illustrated in FIG. 22A, in a case where the read request including the file name is input from the AP 123, the management server 101 reads the values from all corresponding plurality of pieces of key-value data on the distributed memory storage 301, and transmits the read values to the server 102 as the response.

FIG. 22B is a diagram illustrating the response returned from the management server 101 in a case where the AP 123 designates the file name and the local access.

As illustrated in FIG. 22B, in a case where the read request including the file name and the local access designation is input from the AP 123, the management server 101 reads the value from the plurality of pieces of key-value data on the corresponding server 102, and transmits the read value to the server 102 as the response.

FIG. 22C is a diagram illustrating the response returned from the management server 101 in a case where the AP 123 designates the key.

As illustrated in FIG. 22C, in a case where the read request including the key is input from the AP 123, the management server 101 reads the value corresponding to the key, and transmits the read value to the server 102 as the response. It should be noted that the processing of FIG. 22C is the same processing as normal data reading for the key-value data.

According to the embodiment of this invention, the AP 123 of the server 102 can access a database having a key-value data format by using the file interface. This eliminates the need to create the application that differs depending on the key. Further, by performing local designation, it is possible to access only the necessary data among file data pieces.

It should be noted that in this embodiment, the management server 101 and the server 102 have been described as devices for performing different processings from each other, but the management server 101 may be configured to have the function provided to the server 102, for example, a part of the memory 112 of the management server 101 may be used for the distributed memory storage 301.

### Modified Example 1

This invention can be applied to a mode in which the management server 101 includes the open file information 161. In this case, the management server 101 determines which of the local file management information 132 and the global file management information 132 is accessed based on the open file information 161.

A description is now made of a difference in the read processing (FIG. 18) and the write processing (FIG. 19).

In the read processing, the processing of Step S1802 is different.

The management server 101 identifies the open file information 161, and identifies the virtual node information 1303 based on the identified open file information 161.

In addition, the management server 101 refers to the object management information pointer 1333 within the virtual node information 1303 to determine which of the local file management information 132 and the global file management information 132 is read.

In a case where the object management information pointer 1333 stores the pointer to the global file management information 132, all the pieces of local file management information 126 stored on the distributed memory storage 301 are to be read. On the other hand, in a case where the object management information pointer 1333 stores the pointer to the local file management information 126, the local file management information 126 of one server 102 that forms the distributed memory storage 301 is to be read.

In the case where the object management information pointer 1333 stores the pointer to the global file management information 132, the same processing as FIG. 18 is performed.

On the other hand, in the case where the object management information pointer 1333 stores the pointer to the local file management information 126, the management server 101 is to read the local file management information 126 of the own server 102 that has transmitted the read request.

The other processing is the same.

In the read processing, the processing of Step S1901 is different.

The management server 101 identifies the open file information 161, and identifies the virtual node information 1303 based on the identified open file information 161.

Subsequently, based on the identified information, the management server 101 identifies the virtual node information 1303. In addition, the management server 101 refers to the parent VFS pointer 1331 of the identified virtual node information 1303 to identify the directory in which the file is placed by following such a relationship as illustrated in FIG. 13. Accordingly, it is possible to identify the directory management information 135 corresponding to the directory.

In addition, the management server 101 refers to the object management information pointer 1333 of the identified virtual node information 1303 to identify the write destination.

In the case where the object management information pointer 1333 stores the pointer to the global file management information 132, the same processing as FIG. 19 is performed.

On the other hand, in the case where the object management information pointer 1333 stores the pointer to the local file management information 126, the management server 101 instructs the server 102 that has transmitted the write request to generate an entry in the own local file management information 132.

It should be noted that the management server 101 transmits information necessary to generate the entry acquired by the same processing as FIG. 19 along with the instruction.

The server 102 that has received the instruction writes data based on the received information.

### Modified Example 2

In another embodiment, it is possible to employ a method of performing the processing such as the open processing, the read processing, and the write processing for the file by using a dedicated library. In other words, a dedicated library function is used as a function of executing the processing such as the open processing, the read processing, and the write processing for the file.

In a case where the AP 123 uses the dedicated library function, in the library, it is first determined whether or not an operation is performed for the file on the distributed memory storage 301. Examples of the determination may include a method of determining whether or not the file name is set to include a specific directory name.

In other words, in the open processing according to the first embodiment illustrated in FIG. 17, the management server 101 determines in the determination of Step S1701 that the file is stored on the distributed memory storage 301 in a case where the subject file includes the specific directory name, and executes the processing of Step S1702 and the subsequent steps in the library. On the other hand, In a case where the subject file does not include the specific directory name, the management server 101 executes a conventional open function as a normal file operation.

In a case where it is determined that the file is stored on the distributed memory storage 301, as a return value from the open function, the management server 101 returns a value corresponding to the file descriptor returned by the above-mentioned normal open function as the file descriptor within the library. In the subsequent read and write requests received from the AP 123, the file descriptor within the library is designated, to thereby enable the same processing as FIGS. 18 and 19.

Though the detailed description has been given of this invention referring to the attached drawings, this invention is not limited to this specific configuration, and includes various variations and equivalent configurations within the scope of the accompanying claims.

What is claimed is:

1. A computer system, comprising:
a plurality of computers for storing data;
a management computer for managing the data stored on each of the plurality of computers; and
a storage generated by integrating storage areas provided to each of the plurality of computers,
each of the plurality of computers each having:
a first processor;
a first memory coupled to the first processor; and
a first network interface coupled to the first processor,
the management computer having:
a second processor;
a second memory coupled to the second processor; and
a second network interface coupled to the second processor,
the storage divides a file including a plurality of pieces of file data, and stores a plurality of pieces of division data, each of which is formed of a search key and one of the plurality of pieces of file data, in the storage areas that form the storage in a distributed manner, wherein
the management computer includes:
an access management module for controlling access to the storage; and
a storage management module for managing the storage;
the management computer stores:
storage configuration information including information on the storage areas that form the storage; and
file management information including information relevant to placement of the plurality of pieces of division data stored on the storage;
the storage management module stores:
file identification information including information for identifying the file corresponding to the plurality of pieces of division data stored on the storage and a file system in which the file is stored; and
file system management information including placement definition information for defining a placement method for the plurality of pieces of division data on the storage on which the file system is built;
the each of the plurality of computers has:
an application for processing data in units of the plurality of pieces of file data; and
a data access management module for accessing the storage; and
the management computer is configured to:
identify the file system being a storage destination of a given file based on the file identification information on the given file, and retrieve the file system management information corresponding to the identified file system, in a case of receiving a file generation request including the file identification information on the given file from at least one of the applications;
register the file identification information on the given file in the retrieved file system management information;
refer to the storage configuration information and the retrieved file system management information to determine the placement method for the plurality of pieces of division data, generated from the plurality of pieces of file data of the given file, to the storage areas that form the storage;
generate the file management information based on the determined placement method;
refer to the file management information based on the file identification information on a given file to identify the plurality of computers that store the plurality of pieces of division data of the given file, in a case of receiving an access request including the file identification information on the given file from at least one of the applications; and
set a pointer for access to the plurality of pieces of division data of the given file stored on the identified plurality of computers.

2. The computer system according to claim 1, wherein:
the each of the plurality of computers stores divided data management information for managing the plurality of pieces of division data stored in the storage areas provided to the plurality of computers which form the storage; and
the management computer is further configured to:
generate the divided data management information based on the determined placement method after determining the placement method for the plurality of pieces of division data of the given file to the storage areas that form the storage;
store the pointer for access to the generated divided data management information in the file system management information; and
transmit the generated divided data management information to the each of the plurality of computers based on the determined placement method.

3. The computer system according to claim 2, wherein:
the file system having a hierarchical directory structure is built on the storage;
the management computer stores the file system management information for each directory;
the file system management information includes division data definition information for defining a structure of the search key and one of the plurality of pieces of file data within each of the plurality of pieces of division data stored in the file system;
the division data definition information includes information for defining the structure of the search key and the one of the plurality of pieces of file data within each of the plurality of pieces of division data of the file stored under the directory; and
the placement definition information includes information relevant to the placement method for the plurality of pieces of division data of the file stored under the directory.

4. The computer system according to claim 3, wherein:
the management computer is further configured to:
identify the directory to which the plurality of pieces of file data of a first file are written based on the file identification information on the first file, in a case of receiving a write request for the plurality of pieces of file data including the file identification information on the first file from at least one of the applications;
refer to the placement definition information included in the file system management information corresponding to the identified directory to determine the plurality of computers on which a plurality of pieces of first division data, which is generated from the plurality of pieces of file data of the first file, are placed;
refer to the division data definition information included in the file system management information corresponding to the identified directory to generate the plurality of pieces of first division data from the plurality of pieces of file data of the first file which are written to a directory under the identified directory; and
transmit the generated plurality of pieces of first division data to the determined plurality of computers; and
the each of the plurality of computers stores the received plurality of pieces of first division data in the storage areas provided to the each of the plurality of computers which form the storage, and stores the pointer for access to the stored plurality of pieces of first division data in the divided data management information, in a case of receiving the plurality of pieces of first division data.

5. The computer system according to claim 4, wherein:
the write request for the plurality of pieces of file data including the file identification information on the first file transmitted from the at least one of the applications includes information for designating the writing to specific divided data management information; and
the management computer is configured to:
refer to the file management information to identify the plurality of computers storing the specific divided data management information, in a case of receiving the write request for the plurality of pieces of file data including the information for designating the writing to the specific divided data management information; and
transmit the generated plurality of pieces of first division data to the identified plurality of computers.

6. The computer system according to claim 3, wherein:
the management computer is configured to:
identify at least one of the plurality of computers from which the plurality of pieces of file data of a first file are read based on the file identification information on the first file, in a case of receiving a read request for the plurality of pieces of file data including the file identification information on the first file from at least one of the applications; and
transmit the read request for a plurality of pieces of first division data generated from the plurality of pieces of file data of the first file to the at least one of the plurality of computers that has been identified;
the each of the plurality of computers is configured to:
refer to the divided data management information to retrieve the plurality of pieces of first division data, in a case of receiving the read request; and
transmit the plurality of pieces of file data of the first file obtained from the retrieved plurality of pieces of first division data to the management computer; and
the management computer transmits the plurality of pieces of file data of the first file received from the at least one of the plurality of computers to the at least one of the applications that has transmitted the read request for the plurality of pieces of file data.

7. The computer system according to claim 6, wherein:
the read request for the plurality of pieces of file data including the file identification information on the first file transmitted from the at least one of the applications includes information for designating the reading to specific divided data management information; and
the management computer is configured to:
refer to the file management information to identify the plurality of computers storing the specific divided data management information, in a case of receiving the read request for the plurality of pieces of file data including the information for designating the reading to the specific divided data management information; and
transmit the read request for the plurality of pieces of first division data of the first file to the identified plurality of computers.

8. The computer system according to claim 3, wherein:
the file system includes a first directory and a second directory;
a second file is stored in the first directory;
the storage stores a plurality of pieces of second division data generated from the second file;
the management computer is configured to:
identify the plurality of computers from which the plurality of pieces of file data of the second file are read based on the file identification information on the second file, in a case of receiving a copy request for copying the second file to the second directory including the file identification information on the second file from at least one of the applications; and
transmit a read request for the plurality of pieces of second division data of the second file to the identified plurality of computers;
the each of the plurality of computers is configured to:
refer to the divided data management information to retrieve the plurality of pieces of second division data based on the search key, in case of receiving the read request; and
transmit the plurality of pieces of file data of the second file obtained from the retrieved plurality of pieces of second division data to the management computer;
the management computer is further configured to:
refer, after the plurality of pieces of file data of the second file are read, to the division data definition information included in the file system management information corresponding to the second directory to generate a plurality of pieces of third division data from the plurality of piece of file data of the second file;
refer to the placement definition information included in the file system management information corresponding to the second directory to determine the plurality of computers on which the generated plurality of pieces of third division data are to be placed; and
transmit the generated plurality of pieces of third division data to the determined plurality of computers; and
the each of the plurality of computers stores the received plurality of pieces of third division data in the storage areas provided to the each of the plurality of computers which form the storage, and stores the pointer for access to the stored plurality of pieces of third division data in the divided data management information, in a case of receiving the plurality of pieces of third division data.

9. A data management method for use in a computer system,
the computer system including:
a plurality of computers for storing data;
a management computer for managing the data stored on each of the plurality of computers; and
a storage generated by integrating storage areas provided to the plurality of computers,
each of the plurality of computers having:
a first processor;
a first memory coupled to the first processor; and
a first network interface coupled to the first processor,
the management computer having:
a second processor;
a second memory coupled to the second processor; and
a second network interface coupled to the second processor,
the storage dividing a file including a plurality of pieces of file data, and storing a plurality of pieces of division data, each of which is formed of a search key and one of the plurality of pieces of file data, in the storage areas that form the storage in a distributed manner,
the management computer including:
an access management module for controlling access to the storage; and
a storage management module for managing the storage,
the management computer storing:
storage configuration information including information on the storage areas that form the storage; and
file management information including information relating to placement of the plurality of pieces of division data stored on the storage,
the storage management module storing:
file identification information including information for identifying the file corresponding to the plurality of pieces of division data stored on the storage and a file system in which the file is stored; and
file system management information including placement definition information for defining a placement method for the plurality of pieces of division data on the storage on which the file system is built,
the each of the plurality of computers further having:
an application for processing data in units of the plurality of pieces of file data; and
a data access management module for accessing the storage,
the data management method including:
a first step of identifying, by the management computer, the file system being a storage destination of a given file based on the file identification information on the given file, and retrieving the file system management information corresponding to the identified file system, in a case of receiving a file generation request including the file identification information on the given file from at least one of the applications;
a second step of registering, by the management computer, the file identification information on the given file in the retrieved file system management information;
a third step of referring, by the management computer, to the storage configuration information and the retrieved file system management information to determine the placement method for the plurality of pieces of division data generated from the plurality of pieces of file data of the given file to the storage areas that form the storage;
a fourth step of generating, by the management computer, the file management information based on the determined placement method;
a fifth step of referring, by the management computer to the file management information based on the file identification information on the given file to identify the plurality of computers that store the plurality of pieces of division data of the given file, in a case of receiving an access request including the file identification information on the given file from at least one of the applications; and
a sixth step of setting, by the management computer, a pointer for access to the plurality of pieces of division data corresponding to the given file stored on the identified plurality of computers.

10. The data management method according to claim 9, wherein:
the each of the plurality of computers stores divided data management information for managing the plurality of pieces of division data stored in the storage areas provided to the plurality of computers which form the storage; and
the fourth step includes the steps of:
generating the divided data management information based on the determined placement method;
storing the pointer for access to the generated divided data management information in the file system management information; and
transmitting the generated divided data management information to the each of the plurality of computers based on the determined placement method.

11. The data management method according to claim 10, wherein:
the file system having a hierarchical directory structure is built on the storage;
the management computer stores the file system management information for each directory;
the file system management information further includes division data definition information for defining a structure of the search keys and one of the plurality of pieces of file data within each of the plurality of pieces of division data stored in the file system;
the division data definition information includes information for defining the structure of the search key and the one of the plurality of pieces of file data within each of the plurality of pieces of division data of the file stored under the directory; and
the placement definition information includes information relating to the placement method for the plurality of pieces of division data of the file stored under the directory.

12. The data management method according to claim 11, including:
a seventh step of identifying, by the management computer, the directory to which the plurality of pieces of file data of a first file are written based on the file identification information on the first file, in a case of receiving a write request for the plurality of pieces of file data including the file identification information on the first file from at least one of the applications;
an eighth step of referring, by the management computer, to the placement definition information included in the file system management information corresponding to the identified directory to determine the plurality of computers on which a plurality of pieces of first division data generated from the plurality of pieces of file data of the first file are placed;
a ninth step of referring, by the management computer, to the division data definition information included in the file system management information corresponding to the identified directory to generate the plurality of pieces of first division data from the plurality of pieces of file data of the first file which are written to a directory under the identified directory;
a tenth step of transmitting, by the management computer, the generated plurality of pieces of first division data to the determined plurality of computers; and
an eleventh step of storing, by the each of the plurality of computers, the received plurality of pieces of first division data in the storage areas provided to the plurality of computers which form the storage, and storing the pointer for access to the stored plurality of pieces of first division data in the divided data management information, in a case of receiving the plurality of pieces of first division data.

13. The data management method according to claim 12, wherein:
the write request for the plurality of pieces of file data including the file identification information on the first file transmitted from the at least one of the applications includes information for designating the writing to specific divided data management information;
the eighth step includes a step of referring to the file management information to identify the plurality of computers storing the specific divided data management information, in a case of receiving the write request for the plurality of pieces of file data including the information for designating the writing to the specific divided data management information; and
the tenth step includes a step of transmitting the generated plurality of pieces of first division data to the identified plurality of computers.

14. The data management method according to claim 11, including:
a twelfth step of identifying, by the management computer at least one of the plurality of computers from which the plurality of pieces of file data of a first file are read based on the file identification information on the first file, in a case of receiving a read request for the plurality of pieces of file data including the file identification information on a first file from at least one of the applications;
a thirteenth step of transmitting, by the management computer, the read request for a plurality of pieces of first division data generated from the plurality of pieces of file data of the first file to the at least one of the plurality of computers that has been identified;
a fourteenth step of referring, by the each of the plurality of computers, to the divided data management information to retrieve the plurality of pieces of first division data, in a case of receiving the read request;
a fifteenth step of transmitting, by the each of the plurality of computers, the plurality of pieces of file data of the first file obtained from the retrieved plurality of pieces of first division data to the management computer; and
a sixteenth step of transmitting, by the management computer, the plurality of pieces of file data of the first file received from the at least one of the plurality of computers to the at least one of the applications that has transmitted the read request for the plurality of pieces of file data.

15. The data management method according to claim 14, wherein:
the read request for the plurality of pieces of file data including the file identification information on the first file transmitted from the at least one of the applications includes information for designating the reading to specific divided data management information; and
the fifteenth step includes the steps of:
referring, to the file management information to identify the plurality of computers storing the specific divided data management information, in a case of receiving the read request for the plurality of pieces of file data including the information for designating the reading to the specific divided data management information; and
transmitting the read request for the plurality of pieces of first division data of the first file to the identified plurality of computers.

16. The data management method according to claim 11, wherein:
the file system includes a first directory and a second directory;
a second file is stored in the first directory;
the storage stores a plurality of pieces of second division data generated from the second file; and
the data management method includes:
a seventeenth step of identifying, by the management computer, the plurality of computers from which the plurality of pieces of file data of the second file are read based on the file identification information on the second file, in a case of receiving a copy request for copying the second file to the second directory including the file identification information on the second file from at least one of the applications;
an eighteenth step of transmitting, by the management computer, a read request for the plurality of pieces of second division data of the second file to the identified plurality of computers;
a nineteenth step of referring, by the each of the plurality of computers, to the divided data management information to retrieve the plurality of pieces of second division data based on the search key, in a case of receiving the read request;
a twentieth step of transmitting, by the each of the plurality of computers, the plurality of pieces of file data of the second file obtained from the retrieved plurality of pieces of second division data to the management computer;
a twenty-first step of referring, by the management computer, after the plurality of pieces of file data of the second file are read, to the division data definition information included in the file system management information corresponding to the second directory to generate plurality of pieces of third division data from the plurality of pieces of file data of the second file;
a twenty-second step of referring, by the management computer, to the placement definition information included in the file system management information corresponding to the second directory to determine the plurality of computers on which the generated plurality of pieces of third division data are to be placed;
a twenty-third step of transmitting, by the management computer, the generated plurality of pieces of third division data to the determined plurality of computers; and
a twenty-fourth step of storing, by the each of the plurality of computers, the received plurality of pieces of third division data in the storage areas provided to the each of the plurality of computers which form the storage, and storing, by the each of the plurality of computers, the pointer for access to the stored plurality of pieces of third division data in the divided data management information, in a case of receiving the third plurality of pieces of division data.
